(19) United States
(12) Patent Application Publication
(10) Pub. No.: US 2024/0235775 A1
(43) Pub. Date: Jul. 11, 2024

(54) CONFIGURATION AND COLLISION HANDLING FOR SIMULTANEOUS UPLINK TRANSMISSION USING MULTIPLE ANTENNA PANELS

(71) Applicant: Intel Corporation, Santa Clara, CA (US)

(72) Inventors: Guotong WANG, Santa Clara, CA (US); Alexei DAVYDOV, Santa Clara, CA (US)

(21) Appl. No.: 18/560,326

(22) PCT Filed: Dec. 15, 2022
(86) PCT No.: PCT/US2022/053030

§ 371 Date: Nov. 10, 2023

(30) Foreign Application Priority Data
Dec. 17, 2021 (WO) PCT/CN2021/139164
Dec. 20, 2021 (WO) PCT/CN2021/139487

(51) Int. Cl. H04L 5/00; H04B 7/0404; H04B 7/06

(52) U.S. Cl. CPC H04L 5/0051; H04B 7/0404; H04B 7/06956; H04L 5/0094

(57) ABSTRACT

Systems, apparatuses, methods, and computer-readable media are provided for configuration and collision handling for time-overlapped transmission of uplink signals from multiple antenna panels of a user equipment (UE). The uplink signals may include, e.g., a sounding reference signal (SRS) and/or a physical uplink control channel (PUCCH). Other embodiments may be described and claimed.

### CROSS REFERENCE TO RELATED APPLICATION

The present application claims priority to International Patent Application No. PCT/CN2021/139164, which was filed Dec. 17, 2021; and to International Patent Application No. PCT/CN2021/139487, which was filed Dec. 20, 2021.

### FIELD

Various embodiments generally may relate to the field of wireless communications. For example, some embodiments may relate to configuration and/or collision handling for simultaneous uplink transmission using multiple antenna panels.

### BACKGROUND

In 3GPP New Radio (NR) release-15 (Rel-15)/release-16 (Rel-16) specifications, different types of sounding resource signal (SRS) resource sets are supported. The SRS resource set is configured with a parameter of ‘usage’, which can be set to ‘beamManagement’, ‘codebook’, ‘nonCodebook’ or ‘antennaSwitching’. The SRS resource set configured for ‘beamManagement” is used for beam acquisition and uplink beam indication using SRS. The SRS resource set configured for ‘codebook’ and ‘nonCodebook’ is used to determine the UL precoding with explicit indication by transmission precoding matrix index (TPMI) or implicit indication by SRS resource index (SRI). Finally, the SRS resource set configured for ‘antennaSwitching’ is used to acquire DL channel state information (CSI) using SRS measurements in the UE by leveraging reciprocity of the channel in TDD systems. For SRS transmission, the time domain behavior could be periodic, semi-persistent or aperiodic.

Additionally, in NR 5G, the physical uplink control channel (PUCCH) can carry the uplink control information (UCI) including HARQ-ACK, channel state information (CSI) and scheduling request (SR). Multiple PUCCH formats are defined, including PUCCH Format 0 to PUCCH Format 4.

However, the existing configurations and collision handling rules for SRS and PUCCH do not consider and are not adequate for user equipments (UEs) that can transmit simultaneously from multiple antenna panels.

### BRIEF DESCRIPTION OF THE FIGURES

FIG. 1 depicts an example of a radio resource control (RRC) message for sounding reference signal (SRS) resource set configuration, in accordance with various embodiments.

FIG. 2A depicts an example of SRS antenna switching with a single panel.

FIG. 2B depicts an example of SRS configuration for multi-panel operation (e.g., using one resource with multiple spatial relations), in accordance with various embodiments.

FIG. 3 depicts another example of SRS configuration for multi-panel operation (e.g., with an extended number of SRS resources), in accordance with various embodiments.

FIG. 4 depicts another example of SRS configuration for multi-panel operation (e.g., with an extended number of SRS resource sets), in accordance with various embodiments.

FIGS. 5A and 5B depict examples of frequency-division multiplexed (FDMed) PUCCH resources, in accordance with various embodiments.

FIG. 6 illustrates a network in accordance with various embodiments.

FIG. 7 schematically illustrates a wireless network in accordance with various embodiments.

FIG. 8 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 9, 10, and 11 depict example procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Various embodiments herein provide systems, apparatuses, methods, and computer-readable media for configuration and/or collision handling for time-overlapped transmission of uplink signals from multiple antenna panels of a user equipment (UE). The uplink signals may include, e.g., one or more sounding reference signals (SRSs), physical uplink control channels (PUCCH), and/or other suitable uplink signals.

### Multi-Panel SRS Transmission

In NR release-15 (Rel-15)/release-16 (Rel-16) specifications, different types of sounding resource signal (SRS) resource sets are supported. The SRS resource set is configured with a parameter of ‘usage’, which can be set to ‘beamManagement’, ‘codebook’, ‘nonCodebook’ or ‘antennaSwitching’. The SRS resource set configured for ‘beamManagement’ is used for beam acquisition and uplink beam indication using SRS. The SRS resource set configured for ‘codebook’ and ‘nonCodebook’ is used to determine the UL precoding with explicit indication by transmission precoding matrix index (TPMI) or implicit indication by SRS resource index (SRI). Finally, the SRS resource set configured for ‘antennaSwitching’ is used to acquire DL channel state information (CSI) using SRS measurements in the UE by leveraging reciprocity of the channel in TDD systems. For SRS transmission, the time domain behavior could be periodic, semi-persistent or aperiodic.

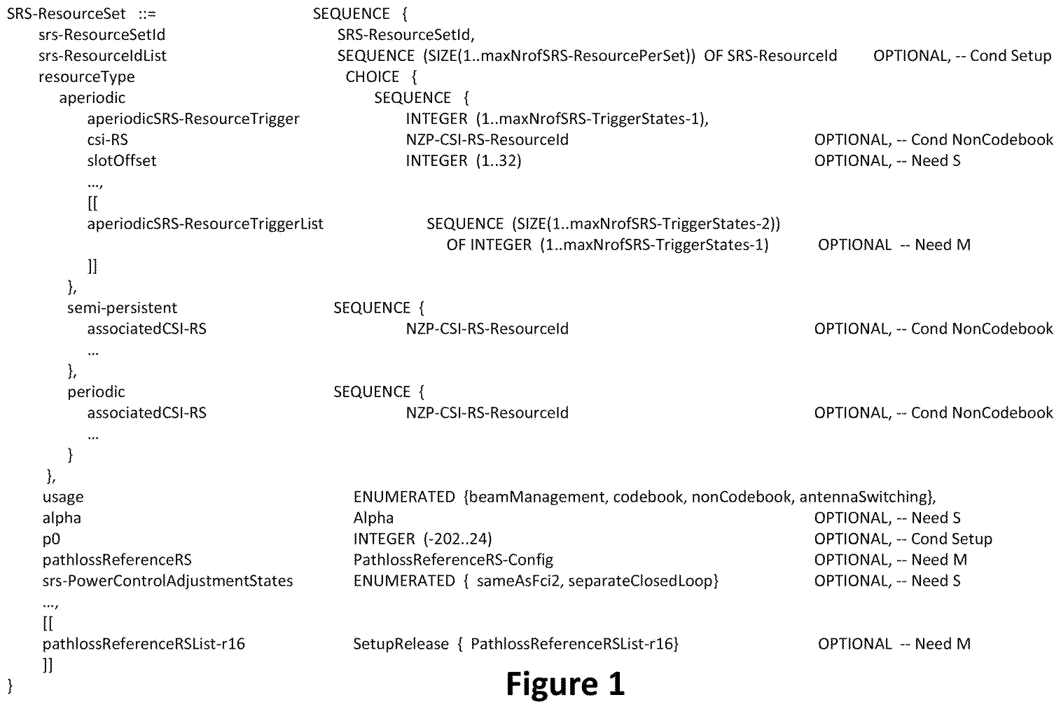

FIG. 1 shows an example of the RRC configuration for SRS resource set. Multiple SRS resource sets may be configured to the UE. Each SRS resource set may be configured with one or multiple SRS resources.

In NR Rel-15/Rel-16 spec, if the SRS transmission collides with other uplink channel/signals, e.g., physical uplink control channel (PUCCH)/physical uplink shared channel (PUSCH)/physical random access channel (PRACH)/SRS, then a collision handling rule may be followed to determine the priority. An example of a legacy collision handling rule for SRS in the Rel-16 specifications (3GPP Technical Specification (TS) 38.214, V16.8.0, Section 6.2.1) is as follows:
For PUCCH and SRS on the same carrier, a UE shall not transmit SRS when semi-persistent and periodic SRS are configured in the same symbol(s) with PUCCH carrying only CSI report(s), or only LI-RSRP report(s), or only LI-SINR report(s). A UE shall not transmit SRS when semi-persistent or periodic SRS is configured or aperiodic SRS is triggered to be transmitted in the same symbol(s) with PUCCH carrying HARQ-ACK, link recovery request (as defined in clause 9.2.4 of [6, 38.213]) and/or SR. In the case that SRS is not transmitted due to overlap with PUCCH, only the SRS symbol(s) that overlap with PUCCH symbol(s) are dropped. PUCCH shall not be transmitted when aperiodic SRS is triggered to be transmitted to overlap in the same symbol with PUCCH carrying semi-persistent/periodic CSI report(s) or semi-persistent/periodic LI-RSRP report(s) only, or only LI-SINR report(s).
In case of intra-band carrier aggregation or in inter-band CA band-band combination where simultaneous SRS and PUCCH/PUSCH transmissions are not allowed, a UE is not expected to be configured with SRS from a carrier and PUSCH/UL DM-RS/UL PT-RS/PUCCH formats from a different carrier in the same symbol.
In case of intra-band carrier aggregation or in inter-band CA band-band combination where simultaneous SRS and PRACH transmissions are not allowed, a UE shall not transmit simultaneously SRS resource(s) from a carrier and PRACH from a different carrier.
In case a SRS resource with resource Type set as ‘aperiodic’ is triggered on the OFDM symbol(s) configured with periodic/semi-persistent SRS transmission, the UE shall transmit the aperiodic SRS resource and only the periodic/semi-persistent SRS symbol(s) overlapping within the symbol(s) are dropped, while the periodic/semi-persistent SRS symbol(s) that are not overlapped with the aperiodic SRS resource are transmitted. In case a SRS resource with resource Type set as ‘semi-persistent’ is triggered on the OFDM symbol(s) configured with periodic SRS transmission, the UE shall transmit the semi-persistent SRS resource and only the periodic SRS symbol(s) overlapping within the symbol(s) are dropped, while the periodic SRS symbol(s) that are not overlapped with the semi-persistent SRS resource are transmitted.

In Rel-18, simultaneous transmission from multiple UE antenna panels may be supported. The legacy SRS transmission and collision handling techniques may not consider or be adequate for simultaneous transmission from multiple UE panels. Various embodiments herein provide techniques for SRS resource configuration to enable SRS transmission using multiple antenna panels (e.g., simultaneous transmission using multiple panels). The collision handling rule may also be enhanced considering the simultaneous transmission from multiple panels.

### Enhanced SRS Transmission

In an embodiment, for a UE supporting simultaneous uplink transmission from multiple panels, one SRS resource may be configured with multiple spatial relations. If the number of simultaneous active UE antenna panels is N, then one SRS resource may be configured with N spatial relations; one spatial relation corresponds to one UE antenna panel. The SRS resource may be also configured with multiple (e.g., N) close loop power control states, multiple (e.g., N) pathloss reference signals; in other words, one close loop power control state/pathloss reference signal may correspond to one UE panel.

The number of SRS resource sets of certain time domain behavior for certain SRS usage may be the same as single panel operation (or non-simultaneous transmission from multiple panels). The number of SRS resources within the SRS resource set may be the same as single panel operation (or non-simultaneous transmission from multiple panels).

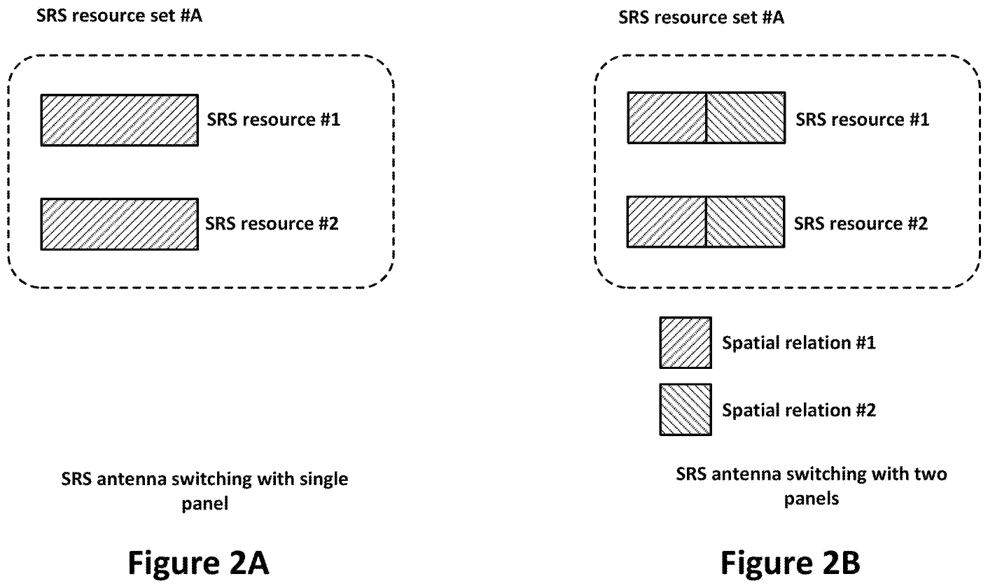

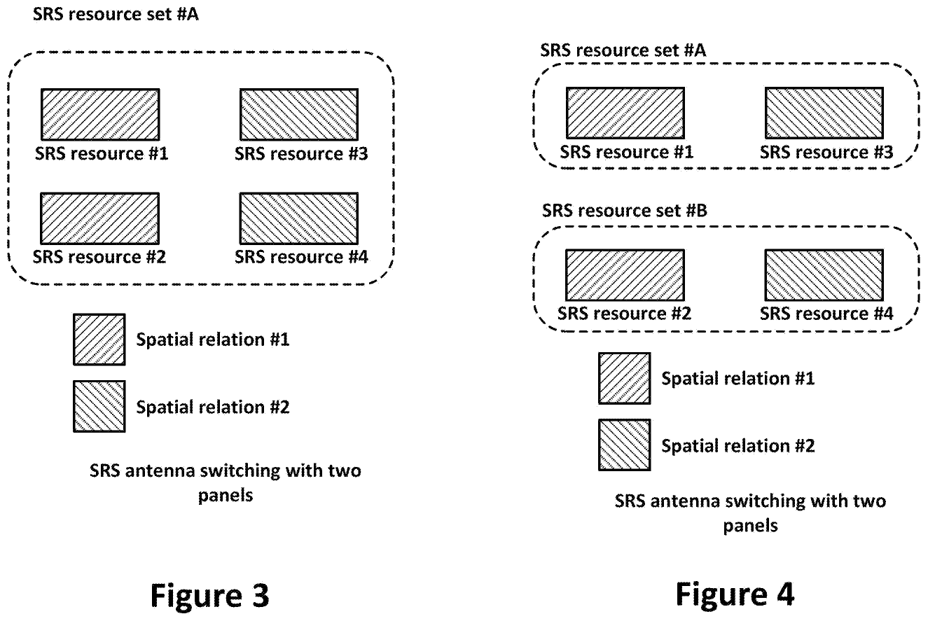

FIG. 2A shows an example of SRS antenna switching with a single panel. FIG. 2B shows an example of SRS configuration for multi-panel transmission, wherein one SRS resource is configured with multiple spatial relations.

The SRS may be one specific usage or any usage of {codebook, nonCodebook, antennaSwitching, beamManagement}. The SRS time domain behavior could be aperiodic, semi-persistent or periodic.

If the user equipment (UE) supports transmission configuration indicator (TCI) states, then multiple (e.g., 2) TCI states could be indicated for SRS over downlink control information (DCI), or updated for SRS via a medium access control (MAC) control element (MAC-CE). The mapping between TCI states and UE antenna panels may be predefined. For example, the 1st TCI state may be pre-defined to be used for the 1st panel, the second TCI state may be used for the 2nd panel, etc.

In order to switch between single panel and multi-panel operation, the MAC-CE may be used to activate/deactivate the spatial relation/TCI state for one or multiple SRS resources. Or DCI may be used to indicate which panel will be used for transmission, for example, a new field could be added to the DCI or some existing fields could be re-purposed.

In an embodiment, for a UE supporting simultaneous uplink transmission from multiple panels, one SRS resource may be configured with only one spatial relation/one close loop power control state/one pathloss reference signal.

The number of SRS resource sets of certain time domain behavior for certain SRS usage may be the same as single panel operation (or non-simultaneous transmission from multiple panels).

The number of SRS resources within one SRS resource set may be extended. For example, if the number of SRS resources in one SRS resource set is K for single panel operation, and if the number of simultaneous active UE antenna panels is N, then the number of SRS resources within one SRS resource set may be K*N.

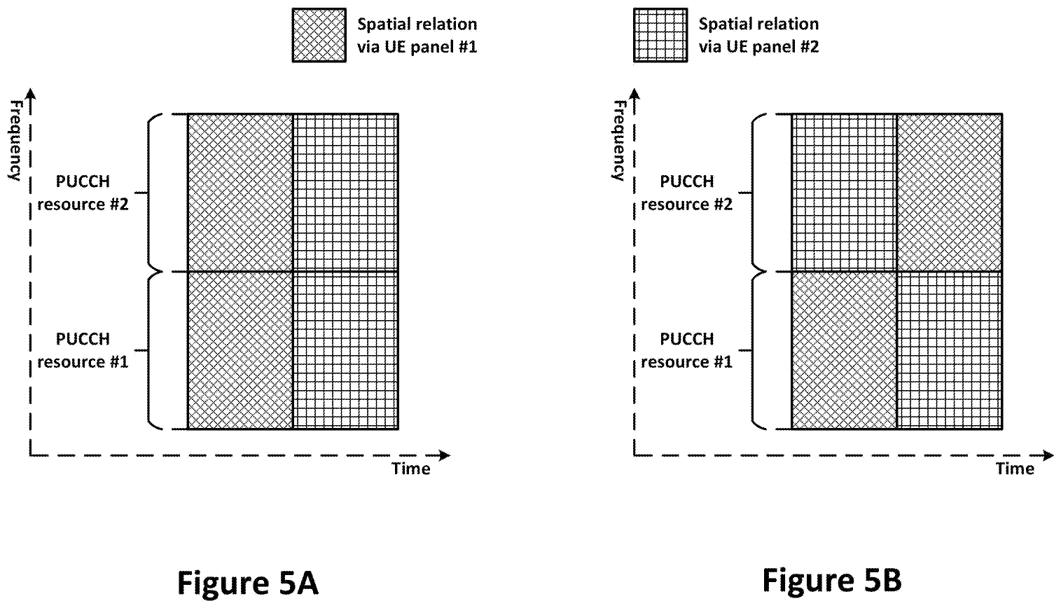

FIG. 3 shows an example of the SRS configuration for multi-panel transmission with the number of SRS resources within one SRS resource set extended.

The SRS may be one specific usage or any usage of {codebook, nonCodebook, antennaSwitching, beamMangement}. The SRS time domain behavior may be aperiodic, semi-persistent or periodic.

If the UE supports TCI states, then multiple (e.g., 2) TCI states could be indicated for SRS over DCI, or updated for SRS via MAC-CE. The mapping between TCI states and UE antenna panels may be predefined. For example, the 1^{st} TCI state may be used for the 1^{st} panel, the second TCI state may be used for the 2^{nd} panel, etc.

In order to switch between single panel and multi-panel operation, MAC-CE may be used to activate/deactivate one or multiple SRS resources. Additionally/alternatively, the DCI may be used to indicate which panel will be used for transmission, for example, a new field could be added to the DCI or some existing fields could be re-purposed.

In another embodiment, for a UE supporting simultaneous uplink transmission from multiple panels, one SRS resource may be configured with only one spatial relation/one close loop power control state/one pathloss reference signal.

The number of SRS resources within one SRS resource set of certain time domain behavior for certain SRS usage may be the same as single panel operation (or non-simultaneous transmission from multiple panels).

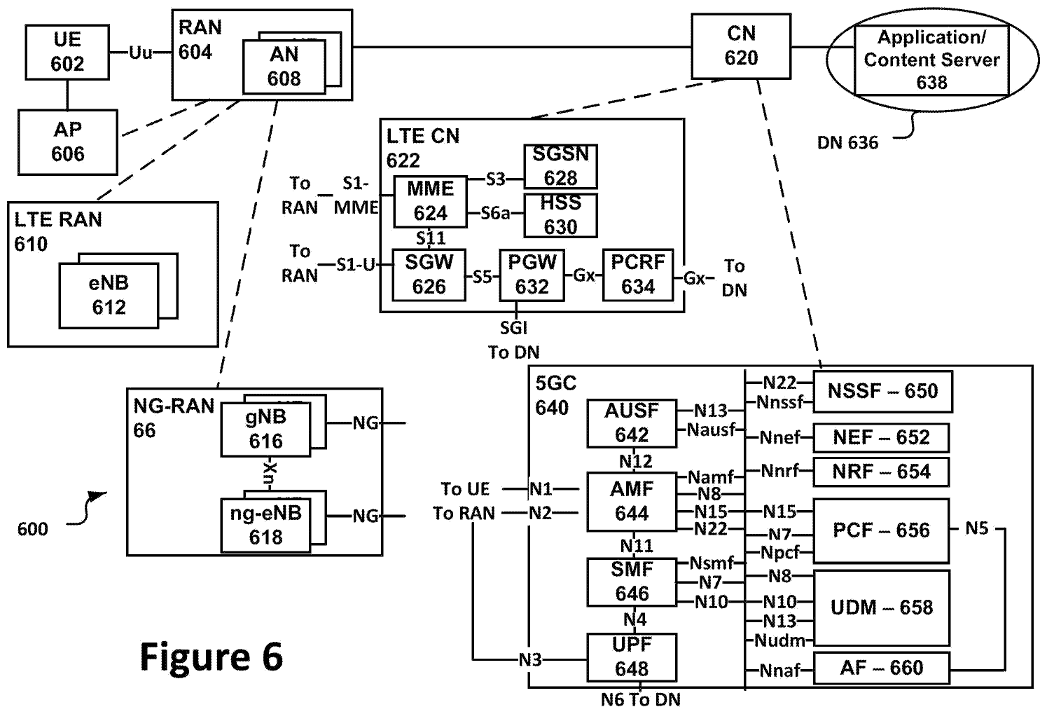

The number of SRS resource sets may be extended. For example, if the number of SRS resource sets is M for single panel operation, and if the number of simultaneous active UE antenna panels is N, then the number of SRS resource sets for multi-panel transmission could be M*N. FIG. 4 shows an example of the SRS configuration for multi-panel transmission with the number of SRS resource sets extended.

The SRS may be one specific usage or any usage of {codebook, nonCodebook, antennaSwitching, beamManagement}. The SRS time domain behavior may be aperiodic, semi-persistent or periodic.

If the UE supports TCI states, then multiple (e.g., 2) TCI states may be indicated for SRS over DCI, or updated for SRS via MAC-CE. The mapping between TCI states and UE antenna panels could be predefined. For example, the 1^{st} TCI state may be used for the 1^{st} panel, the second TCI state may be used for the 2^{nd} panel, etc.

In order to switch between single panel and multi-panel operation, MAC-CE may be used to activate/deactivate one or multiple SRS resource sets. Or DCI may be used to indicate which panel will be used for transmission, for example, a new field may be added to the DCI or some existing fields could be re-purposed.

In an embodiment, for a UE supporting simultaneous uplink transmission from multiple panels, the UE antenna panel may be identified/associated with SRS spatial relation (or TCI state), or SRS close loop power control state. Alternatively, SRS port group may be introduced to identify the UE panels.

### Collision Handling for SRS

In an embodiment, for a UE supporting simultaneous uplink transmission from multiple panels, then multiple SRS resource sets with different spatial relations may be transmitted over the same slot. The SRS resources with different spatial relation may be transmitted over the same (or partially overlapped) symbols and/or over the same (or partially overlapped) frequency resources.

The SRS may be one specific usage or any usage of {codebook, nonCodebook, antennaSwitching, beamMangement}. The SRS time domain behavior may be aperiodic, semi-persistent or periodic.

In an embodiment, for single DCI multi-transmission reception point (TRP) or single TRP operation, the following transmission (over the same carrier or different carrier) may be allowed for a UE supporting simultaneous transmission from multiple panels:
Overlapped SRS transmission: SRS transmission from one panel, and another SRS transmission from another panel.
Overlapped SRS transmission and PUCCH transmission: SRS transmission from one panel, and PUCCH transmission from another panel.
Overlapped SRS transmission and PUSCH transmission: SRS transmission from one panel, and PUSCH transmission from another panel.
Overlapped SRS transmission and PRACH transmission: SRS transmission from one panel, and PRACH transmission from another panel.

For the transmission over the same panel or slot, the existing collision handling rule as described above may be applied for prioritization among SRS/PUCCH/PUSCH/PRACH.

In an embodiment, for multi-DCI, the following transmission (over the same carrier or different carrier) is allowed for UE supporting simultaneous transmission from multiple panels:
Overlapped SRS transmission: SRS transmission from one panel, and another SRS transmission from another panel. The SRS could be aperiodic/semi-persistent/periodic.

For the transmission over the same panel, the existing collision handling rule as described above may be applied for prioritization among SRS/PUCCH/PUSCH/PRACH.

Note: all the embodiments described herein may be applied to single TRP and multi-TRP operation (including single DCI and multi-DCI). All the embodiments could be applied to CP-OFDM and DFT-s-OFDM waveform.

### PUCCH Transmission Using Multiple Antenna Panels

As mentioned above, in NR 5G, the PUCCH can carry the Uplink Control Information (UCI) including HARQ-ACK, channel state information (CSI) and scheduling request (SR). Multiple PUCCH formats are defined, including PUCCH Format 0 to PUCCH Format 4.

In Rel-15/Rel-16, one PUCCH resource can be configured with one spatial relation, e.g., Tx beam, for PUCCH transmission.

In Rel-17, in order to support TDMed PUCCH repetitions in multi-TRP operation, one PUCCH resource could be configured with two spatial relations.

In Rel-15/Rel-16/Rel-17, the prioritization and multiplexing rules have been defined if there is collision among PUCCHs, or there is collision among PUCCH and PUSCH. An example of the collision handling and multiplexing rule for PUCCH and PUSCH, from 3GPP TS 38.213, V16.8.0, Section 9.2.5, is as follows:
For each PUCCH resource in the set Q that satisfies the aforementioned timing conditions, when applicable,
   the UE transmits a PUCCH using the PUCCH resource if the PUCCH resource does not overlap in time with a PUSCH transmission after multiplexing UCI following the procedures described in clauses 9.2.5.1 and 9.2.5.2
   the UE multiplexes HARQ-ACK information and/or CSI reports in a PUSCH if the PUCCH resource overlaps in time with a PUSCH transmission, as described in clause 9.3, and does not transmit SR. In case the PUCCH resource overlaps in time with multiple PUSCH transmissions, the PUSCH for multiplexing HARQ-ACK information and/or CSI is selected as described in clause 9. If the PUSCH transmission by the UE is not in response to a DCI format detection and the UE multiplexes only CSI reports, the timing conditions are not applicable
   the UE does not expect the resource to overlap with a second resource of a PUCCH transmission over multiple slots if the resource is obtained from a group of resources that do not overlap with the second resource.

In Rel-18, the UE can support simultaneous transmission from multiple UE antenna panels. The current PUCCH transmission does not consider simultaneous transmission from multiple UE panels.

Various embodiments herein provide techniques to support PUCCH transmission and collision handling (e.g., prioritization and/or multiplexing of signals) considering simultaneous transmission from multiple UE panels.

### Enhanced PUCCH Transmission

In an embodiment, for UE supporting simultaneous transmission from multiple panels, PUCCH could be transmitted from multiple panels simultaneously. The PUCCH transmitted from multiple panels could be TDMed, FDMed, or SDMed. The simultaneous PUCCH transmission could be applied to one or several specific PUCCH formats or any PUCCH format.

In an embodiment, one PUCCH resource could be transmitted over same or different frequency resources simultaneously via different UE panels.

The mapping between the frequency resource parts and UE panels could be pre-defined. For example, the 1^{st} part of the frequency resource will be transmitted via the 1^{st} panel, and the 2^{nd} part of the frequency resource will be transmitted via the 2^{nd} panel.

In an embodiment, different PUCCH resources could be transmitted over the same or different frequency resources simultaneously via different UE panels.

In one example, one PUCCH resource is configured with TDMed repetition, and another PUCCH resource is also configured with TDMed repetition; then these two PUCCH resource could be further FDMed.

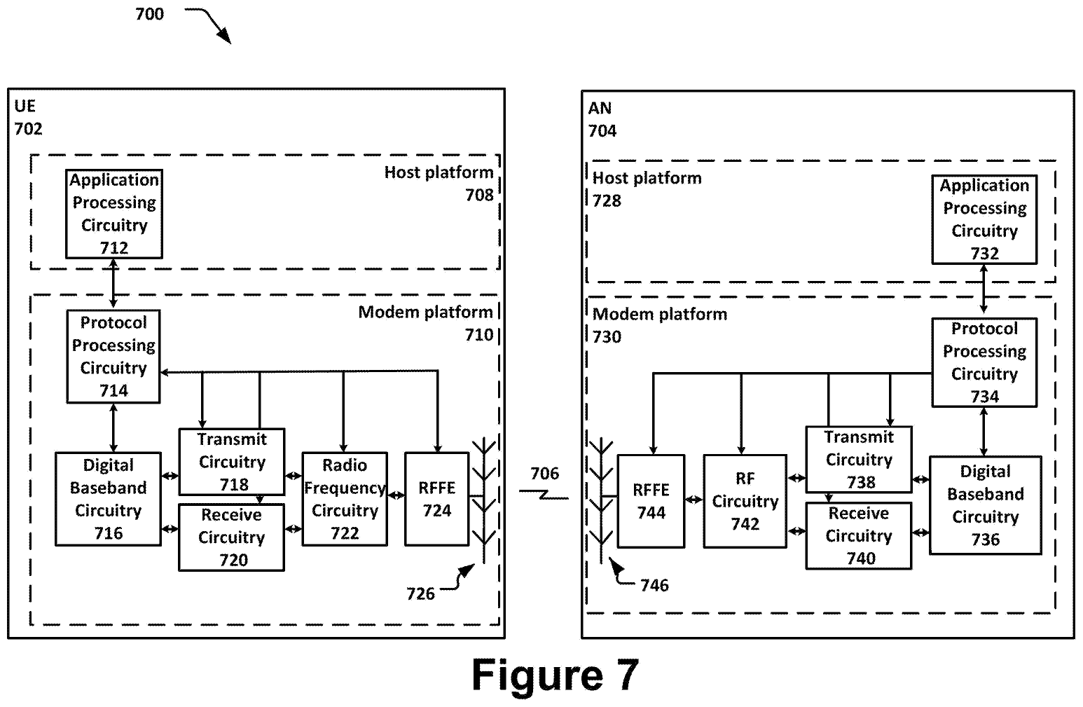

As shown in FIGS. 5A and 5B, PUCCH resource #1 and #2 are configured with TDMed repetitions. In FIG. 5A, these two PUCCH resources are FDMed, while the FDMed parts are transmitted over the same UE panel. In FIG. 5B, these two PUCCH resources are FDMed, while the FDMed parts are transmitted via different UE panel.

### Collision Handling for PUCCH

In an embodiment, for single DCI multi-TRP or single TRP operation, the following transmission (over the same carrier or different carrier) is allowed for UE supporting simultaneous transmission from multiple panels:
Overlapped PUCCH transmission: PUCCH transmission from one panel, and another PUCCH transmission from another panel. The PUCCH over multiple panels could be the same or different PUCCH format. The PUCCH over multiple panels could be the same or different PUCCH resource.
Overlapped PUCCH transmission and PUSCH transmission: PUCCH transmission from one panel, and PUSCH transmission from another panel.
Overlapped PUCCH transmission and SRS transmission: PUCCH transmission from one panel, and SRS transmission from another panel.

In an embodiment, for multi-DCI multi-TRP, the following transmission (over the same carrier or different carrier) is allowed for UE supporting simultaneous transmission from multiple panels:
Overlapped PUCCH transmission: PUCCH transmission from one panel, and another PUCCH transmission from another panel. The PUCCH over multiple panels could be the same or different PUCCH format. The PUCCH over multiple panels could be the same or different PUCCH resource.

### Systems and Implementations

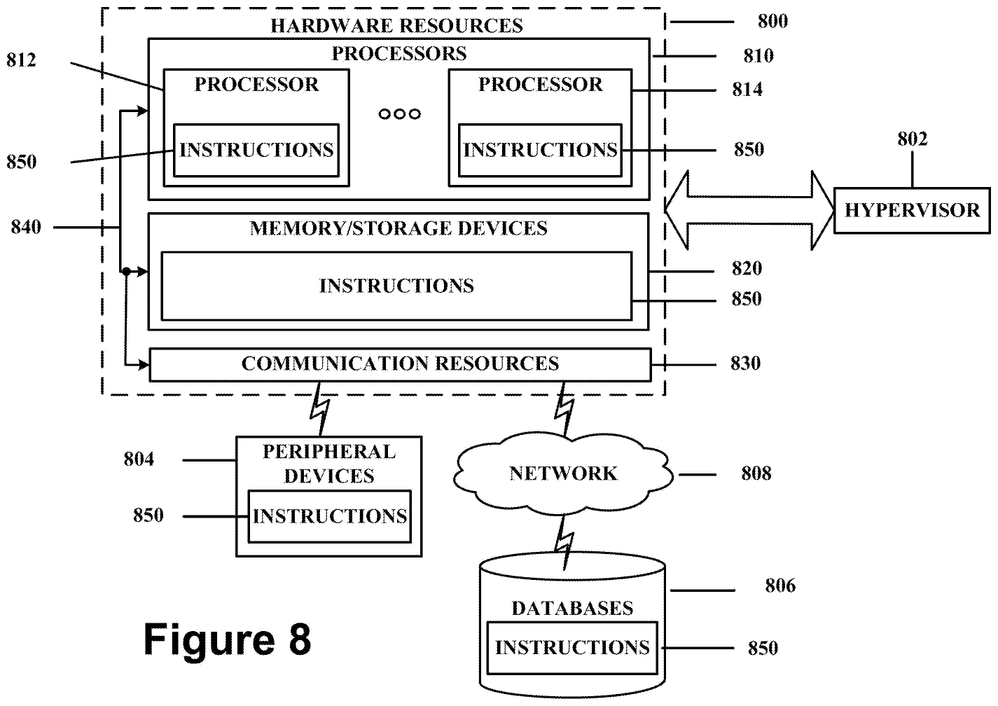

FIGS. 6-8 illustrate various systems, devices, and components that may implement aspects of disclosed embodiments.

FIG. 6 illustrates a network 600 in accordance with various embodiments. The network 600 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 600 may include a UE 602, which may include any mobile or non-mobile computing device designed to communicate with a RAN 604 via an over-the-air connection. The UE 602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 602 may additionally communicate with an AP 606 via an over-the-air connection. The AP 606 may manage a WLAN connection, which may serve to offload some/all network traffic from the RAN 604. The connection between the UE 602 and the AP 606 may be consistent with any IEEE 802.11 protocol, wherein the AP 606 could be a wireless fidelity (Wi-Fi®) router. In some embodiments, the UE 602, RAN 604, and AP 606 may utilize cellular-WLAN aggregation (for example, LWA/LWIP). Cellular-WLAN aggregation may involve the UE 602 being configured by the RAN 604 to utilize both cellular radio resources and WLAN resources.

The RAN 604 may include one or more access nodes, for example, AN 608. AN 608 may terminate air-interface protocols for the UE 602 by providing access stratum protocols including RRC, PDCP, RLC, MAC, and LI protocols. In this manner, the AN 608 may enable data/voice connectivity between CN 620 and the UE 602. In some embodiments, the AN 608 may be implemented in a discrete device or as one or more software entities running on server computers as part of, for example, a virtual network, which may be referred to as a CRAN or virtual baseband unit pool. The AN 608 be referred to as a BS, gNB, RAN node, eNB, ng-eNB, NodeB, RSU, TRxP, TRP, etc. The AN 608 may be a macrocell base station or a low power base station for providing femtocells, picocells or other like cells having smaller coverage areas, smaller user capacity, or higher bandwidth compared to macrocells.

In embodiments in which the RAN 604 includes a plurality of ANs, they may be coupled with one another via an X2 interface (if the RAN 604 is an LTE RAN) or an Xn interface (if the RAN 604 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 604 may each manage one or more cells, cell groups, component carriers, etc. to provide the UE 602 with an air interface for network access. The UE 602 may be simultaneously connected with a plurality of cells provided by the same or different ANs of the RAN 604. For example, the UE 602 and RAN 604 may use carrier aggregation to allow the UE 602 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 604 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 602 or AN 608 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 604 may be an LTE RAN 610 with eNBs, for example, eNB 612. The LTE RAN 610 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 604 may be an NG-RAN 614 with gNBs, for example, gNB 616, or ng-eNBs, for example, ng-eNB 618. The gNB 616 may connect with 5G-enabled UEs using a 5G NR interface. The gNB 616 may connect with a 5G core through an NG interface, which may include an N2 interface or an N3 interface. The ng-eNB 618 may also connect with the 5G core through an NG interface, but may connect with a UE via an LTE air interface. The gNB 616 and the ng-eNB 618 may connect with each other over an Xn interface.

In some embodiments, the NG interface may be split into two parts, an NG user plane (NG-U) interface, which carries traffic data between the nodes of the NG-RAN 614 and a UPF 648 (e.g., N3 interface), and an NG control plane (NG-C) interface, which is a signaling interface between the nodes of the NG-RAN 614 and an AMF 644 (e.g., N2 interface).

The NG-RAN 614 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 602 can be configured with multiple BWPs where each BWP configuration has a different SCS. When a BWP change is indicated to the UE 602, the SCS of the transmission is changed as well. Another use case example of BWP is related to power saving. In particular, multiple BWPs can be configured for the UE 602 with different amount of frequency resources (for example, PRBs) to support data transmission under different traffic loading scenarios. A BWP containing a smaller number of PRBs can be used for data transmission with small traffic load while allowing power saving at the UE 602 and in some cases at the gNB 616. A BWP containing a larger number of PRBs can be used for scenarios with higher traffic load.

The RAN 604 is communicatively coupled to CN 620 that includes network elements to provide various functions to support data and telecommunications services to customers/subscribers (for example, users of UE 602). The components of the CN 620 may be implemented in one physical node or separate physical nodes. In some embodiments, NFV may be utilized to virtualize any or all of the functions provided by the network elements of the CN 620 onto physical compute/storage resources in servers, switches, etc. A logical instantiation of the CN 620 may be referred to as a network slice, and a logical instantiation of a portion of the CN 620 may be referred to as a network sub-slice.

In some embodiments, the CN 620 may be an LTE CN 622, which may also be referred to as an EPC. The LTE CN 622 may include MME 624, SGW 626, SGSN 628, HSS 630, PGW 632, and PCRF 634 coupled with one another over interfaces (or “reference points”) as shown. Functions of the elements of the LTE CN 622 may be briefly introduced as follows.

The MME 624 may implement mobility management functions to track a current location of the UE 602 to facilitate paging, bearer activation/deactivation, handovers, gateway selection, authentication, etc.

The SGW 626 may terminate an S1 interface toward the RAN and route data packets between the RAN and the LTE CN 622. The SGW 626 may be a local mobility anchor point for inter-RAN node handovers and also may provide an anchor for inter-3GPP mobility. Other responsibilities may include lawful intercept, charging, and some policy enforcement.

The SGSN 628 may track a location of the UE 602 and perform security functions and access control. In addition, the SGSN 628 may perform inter-EPC node signaling for mobility between different RAT networks; PDN and S-GW selection as specified by MME 624; MME selection for handovers; etc. The S3 reference point between the MME 624 and the SGSN 628 may enable user and bearer information exchange for inter-3GPP access network mobility in idle/active states.

The HSS 630 may include a database for network users, including subscription-related information to support the network entities' handling of communication sessions. The HSS 630 can provide support for routing/roaming, authentication, authorization, naming/addressing resolution, location dependencies, etc. An S6a reference point between the HSS 630 and the MME 624 may enable transfer of subscription and authentication data for authenticating/authorizing user access to the LTE CN 620.

The PGW 632 may terminate an SGi interface toward a data network (DN) 636 that may include an application/content server 638. The PGW 632 may route data packets between the LTE CN 622 and the data network 636. The PGW 632 may be coupled with the SGW 626 by an S5 reference point to facilitate user plane tunneling and tunnel management. The PGW 632 may further include a node for policy enforcement and charging data collection (for example, PCEF). Additionally, the SGi reference point between the PGW 632 and the data network 636 may be an operator external public, a private PDN, or an intra-operator packet data network, for example, for provision of IMS services. The PGW 632 may be coupled with a PCRF 634 via a Gx reference point.

The PCRF 634 is the policy and charging control element of the LTE CN 622. The PCRF 634 may be communicatively coupled to the app/content server 638 to determine appropriate QoS and charging parameters for service flows. The PCRF 632 may provision associated rules into a PCEF (via Gx reference point) with appropriate TFT and QCI.

In some embodiments, the CN 620 may be a 5GC 640. The 5GC 640 may include an AUSF 642, AMF 644, SMF 646, UPF 648, NSSF 650, NEF 652, NRF 654, PCF 656, UDM 658, and AF 660 coupled with one another over interfaces (or “reference points”) as shown. Functions of the elements of the 5GC 640 may be briefly introduced as follows.

The AUSF 642 may store data for authentication of UE 602 and handle authentication-related functionality. The AUSF 642 may facilitate a common authentication framework for various access types. In addition to communicating with other elements of the 5GC 640 over reference points as shown, the AUSF 642 may exhibit an Nausf service-based interface.

The AMF 644 may allow other functions of the 5GC 640 to communicate with the UE 602 and the RAN 604 and to subscribe to notifications about mobility events with respect to the UE 602. The AMF 644 may be responsible for registration management (for example, for registering UE 602), connection management, reachability management, mobility management, lawful interception of AMF-related events, and access authentication and authorization. The AMF 644 may provide transport for SM messages between the UE 602 and the SMF 646, and act as a transparent proxy for routing SM messages. AMF 644 may also provide transport for SMS messages between UE 602 and an SMSF. AMF 644 may interact with the AUSF 642 and the UE 602 to perform various security anchor and context management functions. Furthermore, AMF 644 may be a termination point of a RAN CP interface, which may include or be an N2 reference point between the RAN 604 and the AMF 644; and the AMF 644 may be a termination point of NAS (N1) signaling, and perform NAS ciphering and integrity protection. AMF 644 may also support NAS signaling with the UE 602 over an N3 IWF interface.

The SMF 646 may be responsible for SM (for example, session establishment, tunnel management between UPF 648 and AN 608); UE IP address allocation and management (including optional authorization); selection and control of UP function; configuring traffic steering at UPF 648 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 644 over N2 to AN 608; and determining SSC mode of a session. SM may refer to management of a PDU session, and a PDU session or “session” may refer to a PDU connectivity service that provides or enables the exchange of PDUs between the UE 602 and the data network 636.

The UPF 648 may act as an anchor point for intra-RAT and inter-RAT mobility, an external PDU session point of interconnect to data network 636, and a branching point to support multi-homed PDU session. The UPF 648 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 648 may include an uplink classifier to support routing traffic flows to a data network.

The NSSF 650 may select a set of network slice instances serving the UE 602. The NSSF 650 may also determine allowed NSSAI and the mapping to the subscribed S-NSSAIs, if needed. The NSSF 650 may also determine the AMF set to be used to serve the UE 602, or a list of candidate AMFs based on a suitable configuration and possibly by querying the NRF 654. The selection of a set of network slice instances for the UE 602 may be triggered by the AMF 644 with which the UE 602 is registered by interacting with the NSSF 650, which may lead to a change of AMF. The NSSF 650 may interact with the AMF 644 via an N22 reference point; and may communicate with another NSSF in a visited network via an N31 reference point (not shown). Additionally, the NSSF 650 may exhibit an Nnssf service-based interface.

The NEF 652 may securely expose services and capabilities provided by 3GPP network functions for third party, internal exposure/re-exposure, AFs (e.g., AF 660), edge computing or fog computing systems, etc. In such embodiments, the NEF 652 may authenticate, authorize, or throttle the AFs. NEF 652 may also translate information exchanged with the AF 660 and information exchanged with internal network functions. For example, the NEF 652 may translate between an AF-Service-Identifier and an internal 5GC information. NEF 652 may also receive information from other NFs based on exposed capabilities of other NFs. This information may be stored at the NEF 652 as structured data, or at a data storage NF using standardized interfaces. The stored information can then be re-exposed by the NEF 652 to other NFs and AFs, or used for other purposes such as analytics. Additionally, the NEF 652 may exhibit an Nnef service-based interface.

The NRF 654 may support service discovery functions, receive NF discovery requests from NF instances, and provide the information of the discovered NF instances to the NF instances. NRF 654 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 654 may exhibit the Nnrf service-based interface.

The PCF 656 may provide policy rules to control plane functions to enforce them, and may also support unified policy framework to govern network behavior. The PCF 656 may also implement a front end to access subscription information relevant for policy decisions in a UDR of the UDM 658. In addition to communicating with functions over reference points as shown, the PCF 656 exhibit an Npcf service-based interface.

The UDM 658 may handle subscription-related information to support the network entities' handling of communication sessions, and may store subscription data of UE 602. For example, subscription data may be communicated via an N8 reference point between the UDM 658 and the AMF 644. The UDM 658 may include two parts, an application front end and a UDR. The UDR may store subscription data and policy data for the UDM 658 and the PCF 656, and/or structured data for exposure and application data (including PFDs for application detection, application request information for multiple UEs 602) for the NEF 652. The Nudr service-based interface may be exhibited by the UDR 221 to allow the UDM 658, PCF 656, and NEF 652 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 658 may exhibit the Nudm service-based interface.

The AF 660 may provide application influence on traffic routing, provide access to NEF, and interact with the policy framework for policy control.

In some embodiments, the 5GC 640 may enable edge computing by selecting operator/3rd party services to be geographically close to a point that the UE 602 is attached to the network. This may reduce latency and load on the network. To provide edge-computing implementations, the 5GC 640 may select a UPF 648 close to the UE 602 and execute traffic steering from the UPF 648 to data network 636 via the N6 interface. This may be based on the UE subscription data, UE location, and information provided by the AF 660. In this way, the AF 660 may influence UPF (re)selection and traffic routing. Based on operator deployment, when AF 660 is considered to be a trusted entity, the network operator may permit AF 660 to interact directly with relevant NFs. Additionally, the AF 660 may exhibit an Naf service-based interface.

The data network 636 may represent various network operator services, Internet access, or third party services that may be provided by one or more servers including, for example, application/content server 638.

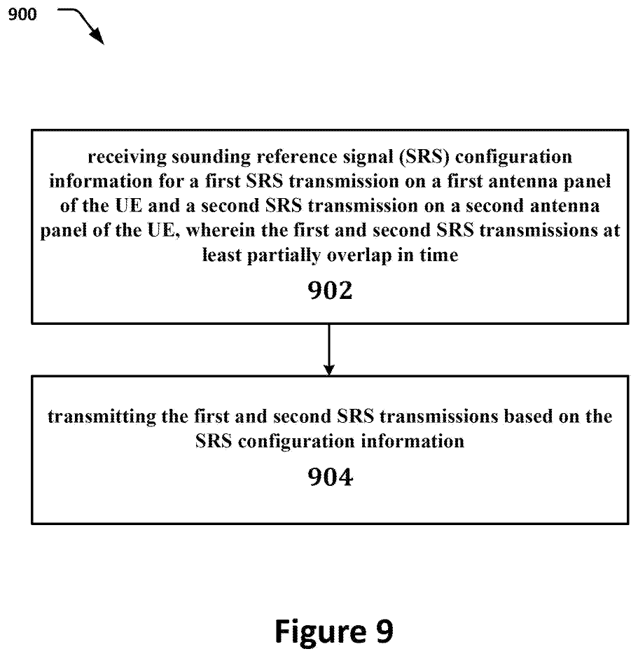

FIG. 7 schematically illustrates a wireless network 700 in accordance with various embodiments. The wireless network 700 may include a UE 702 in wireless communication with an AN 704. The UE 702 and AN 704 may be similar to, and substantially interchangeable with, like-named components described elsewhere herein.

The UE 702 may be communicatively coupled with the AN 704 via connection 706. The connection 706 is illustrated as an air interface to enable communicative coupling, and can be consistent with cellular communications protocols such as an LTE protocol or a 5G NR protocol operating at mm Wave or sub-6 GHZ frequencies.

The UE 702 may include a host platform 708 coupled with a modem platform 710. The host platform 708 may include application processing circuitry 712, which may be coupled with protocol processing circuitry 714 of the modem platform 710. The application processing circuitry 712 may run various applications for the UE 702 that source/sink application data. The application processing circuitry 712 may further implement one or more layer operations to transmit/receive application data to/from a data network. These layer operations may include transport (for example UDP) and Internet (for example, IP) operations

The protocol processing circuitry 714 may implement one or more of layer operations to facilitate transmission or reception of data over the connection 706. The layer operations implemented by the protocol processing circuitry 714 may include, for example, MAC, RLC, PDCP, RRC and NAS operations.

The modem platform 710 may further include digital baseband circuitry 716 that may implement one or more layer operations that are “below” layer operations performed by the protocol processing circuitry 714 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 710 may further include transmit circuitry 718, receive circuitry 720, RF circuitry 722, and RF front end (RFFE) 724, which may include or connect to one or more antenna panels 726. Briefly, the transmit circuitry 718 may include a digital-to-analog converter, mixer, intermediate frequency (IF) components, etc.; the receive circuitry 720 may include an analog-to-digital converter, mixer, IF components, etc.; the RF circuitry 722 may include a low-noise amplifier, a power amplifier, power tracking components, etc.; RFFE 724 may include filters (for example, surface/bulk acoustic wave filters), switches, antenna tuners, beamforming components (for example, phase-array antenna components), etc. The selection and arrangement of the components of the transmit circuitry 718, receive circuitry 720, RF circuitry 722, RFFE 724, and antenna panels 726 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 714 may include one or more instances of control circuitry (not shown) to provide control functions for the transmit/receive components.

A UE reception may be established by and via the antenna panels 726, RFFE 724, RF circuitry 722, receive circuitry 720, digital baseband circuitry 716, and protocol processing circuitry 714. In some embodiments, the antenna panels 726 may receive a transmission from the AN 704 by receive-beamforming signals received by a plurality of antennas/antenna elements of the one or more antenna panels 726.

A UE transmission may be established by and via the protocol processing circuitry 714, digital baseband circuitry 716, transmit circuitry 718, RF circuitry 722, RFFE 724, and antenna panels 726. In some embodiments, the transmit components of the UE 704 may apply a spatial filter to the data to be transmitted to form a transmit beam emitted by the antenna elements of the antenna panels 726.

Similar to the UE 702, the AN 704 may include a host platform 728 coupled with a modem platform 730. The host platform 728 may include application processing circuitry 732 coupled with protocol processing circuitry 734 of the modem platform 730. The modem platform may further include digital baseband circuitry 736, transmit circuitry 738, receive circuitry 740, RF circuitry 742, RFFE circuitry 744, and antenna panels 746. The components of the AN 704 may be similar to and substantially interchangeable with like-named components of the UE 702. In addition to performing data transmission/reception as described above, the components of the AN 708 may perform various logical functions that include, for example, RNC functions such as radio bearer management, uplink and downlink dynamic radio resource management, and data packet scheduling.

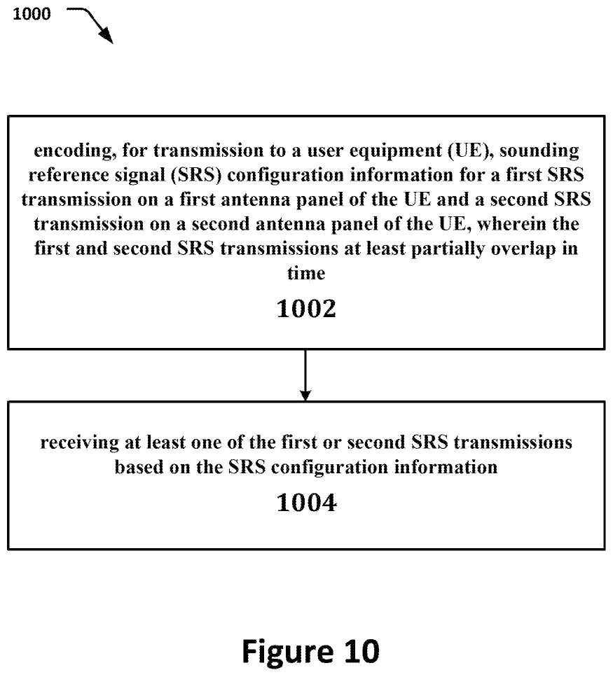

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840 or other interface circuitry. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814. The processors 810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 may include main memory, disk storage, or any suitable combination thereof. The memory/storage devices 820 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 830 may include interconnection or network interface controllers, components, or other suitable devices to communicate with one or more peripheral devices 804 or one or more databases 806 or other network elements via a network 808. For example, the communication resources 830 may include wired communication components (e.g., for coupling via USB, Ethernet, etc.), cellular communication components, NFC components, Bluetooth® (or Bluetooth® Low Energy) components, Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

### Example Procedures

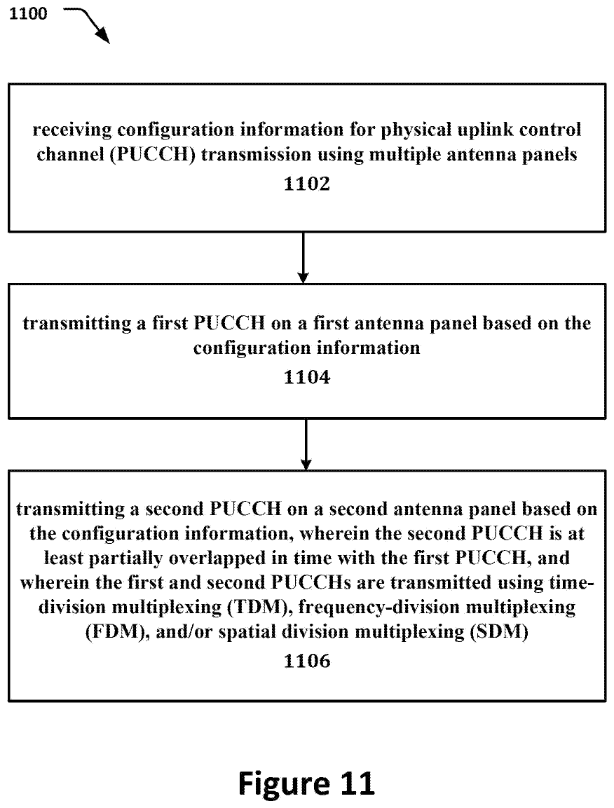

In some embodiments, the electronic device(s), network(s), system(s), chip(s) or component(s), or portions or implementations thereof, of FIGS. 6-8, or some other figure herein, may be configured to perform one or more processes, techniques, or methods as described herein, or portions thereof. One such process 900 is depicted in FIG. 9. The process 900 may be performed, for example, by a UE (or a portion thereof) in a wireless network.

At 902, the process 900 may include receiving sounding reference signal (SRS) configuration information for a first SRS transmission on a first antenna panel of the UE and a second SRS transmission on a second antenna panel of the UE, wherein the first and second SRS transmissions at least partially overlap in time. At 904, the process 900 may further include transmitting the first and second SRS transmissions based on the SRS configuration information.

FIG. 10 illustrates another process 1000 in accordance with various embodiments. The process 1000 may be performed, for example, by a gNB (or a portion thereof) in a wireless network. At 1002, the process 1000 may include encoding, for transmission to a user equipment (UE), sounding reference signal (SRS) configuration information for a first SRS transmission on a first antenna panel of the UE and a second SRS transmission on a second antenna panel of the UE, wherein the first and second SRS transmissions at least partially overlap in time. At 1004, the process 1000 may further include receiving at least one of the first or second SRS transmissions based on the SRS configuration information.

FIG. 11 illustrates another process 1100 in accordance with various embodiments. The process 1100 may be performed, for example, by a UE (or a portion thereof) in a wireless network. At 1102, the process 1100 may include receiving configuration information for physical uplink control channel (PUCCH) transmission using multiple antenna panels. At 1104, the process 1100 may further include transmitting a first PUCCH on a first antenna panel based on the configuration information. At 1106, the process 1100 may further include transmitting a second PUCCH on a second antenna panel based on the configuration information, wherein the second PUCCH is at least partially overlapped in time with the first PUCCH, and wherein the first and second PUCCHs are transmitted using time-division multiplexing (TDM), frequency-division multiplexing (FDM), and/or spatial division multiplexing (SDM).

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example A1 may include one or more non-transitory computer-readable media (NTCRM) having instructions, stored thereon, that when executed by one or more processors of a user equipment (UE) configure the UE to: receive sounding reference signal (SRS) configuration information for a first SRS transmission on a first antenna panel of the UE and a second SRS transmission on a second antenna panel of the UE, wherein the first and second SRS transmissions at least partially overlap in time; and transmit the first and second SRS transmissions based on the SRS configuration information.

Example A2 may include the one or more NTCRM of example A1, wherein the first SRS transmission and the second SRS transmission are synchronous.

Example A3 may include the one or more NTCRM of example A1-A2, wherein the first SRS transmission and the second SRS transmission are in a same slot.

Example A4 may include the one or more NTCRM of example A1-A3, wherein the SRS configuration information includes a first spatial relation for the first SRS transmission and a second spatial relation for the second SRS transmission.

Example A5 may include the one or more NTCRM of example A1-A4, wherein the SRS configuration information includes a first closed loop power control state for the first SRS transmission and a second closed loop power control state for the second SRS transmission.

Example A6 may include the one or more NTCRM of example A1-A5, wherein the SRS configuration information indicates a first pathloss reference signal related to the first SRS transmission and a second pathloss reference signal related to the second SRS transmission.

Example A7 may include the one or more NTCRM of example A1-A6, wherein the SRS configuration information includes a first transmission configuration indicator (TCI) related to the first transmission and a second TCI related to the second transmission.

Example A8 may include the one or more NTCRM of example A1-A7, wherein the SRS configuration information indicates a plurality of SRS resource sets, and wherein the instructions, when executed, are further to configure the UE to receive a downlink control information (DCI) or a medium access control (MAC) control element (MAC-CE) to indicate one or more of the SRS resource sets to use.

Example A9 may include the one or more NTCRM of example A8, wherein the first and second SRS transmissions are transmitted based on a same spatial relation, closed loop power control state, or pathloss reference signal.

Example A10 may include one or more non-transitory computer-readable media having instructions, stored thereon, that when executed by one or more processors of a next generation Node B (gNB) configure the gNB to: encode, for transmission to a user equipment (UE), sounding reference signal (SRS) configuration information for a first SRS transmission on a first antenna panel of the UE and a second SRS transmission on a second antenna panel of the UE, wherein the first and second SRS transmissions at least partially overlap in time; and receive at least one of the first or second SRS transmissions based on the SRS configuration information.

Example A11 may include the one or more NTCRM of example A10, wherein the first SRS transmission and the second SRS transmission are synchronous.

Example A12 may include the one or more NTCRM of example A10-A11, wherein the first SRS transmission and the second SRS transmission are in a same slot.

Example A13 may include the one or more NTCRM of example A10-A12, wherein the SRS configuration information includes a first spatial relation for the first SRS transmission and a second spatial relation for the second SRS transmission.

Example A14 may include the one or more NTCRM of example A10-A13, wherein the SRS configuration information includes a first closed loop power control state for the first SRS transmission and a second closed loop power control state for the second SRS transmission.

Example A15 may include the one or more NTCRM of example A10-A14, wherein the SRS configuration information indicates a first pathloss reference signal related to the first SRS transmission and a second pathloss reference signal related to the second SRS transmission.

Example A16 may include the one or more NTCRM of example A10-A15, wherein the SRS configuration information includes a first transmission configuration indicator (TCI) related to the first transmission and a second TCI related to the second transmission.

Example A17 may include the one or more NTCRM of example A10-A16, wherein the SRS configuration information indicates a plurality of SRS resource sets, and wherein the instructions, when executed, are further to configure the gNB to transmit a downlink control information (DCI) or a medium access control (MAC) control element (MAC-CE) to the UE to indicate one or more of the SRS resource sets to use.

Example A18 may include the one or more NTCRM of example A17, wherein the SRS configuration information is to configure the UE to transmit the first and second SRS transmissions based on a same spatial relation, closed loop power control state, or pathloss reference signal.

Example A19 may include one or more non-transitory computer-readable media (NTCRM) having instructions, stored thereon, that when executed by one or more processors of a user equipment (UE) configure the UE to: receive configuration information for physical uplink control channel (PUCCH) transmission using multiple antenna panels; transmit a first PUCCH on a first antenna panel based on the configuration information; and transmit a second PUCCH on a second antenna panel based on the configuration information, wherein the second PUCCH is at least partially overlapped in time with the first PUCCH, and wherein the first and second PUCCHs are transmitted using time-division multiplexing (TDM), frequency-division multiplexing (FDM), and/or spatial division multiplexing (SDM).

Example 20 may include the one or more NTCRM of example A19, wherein the configuration information indicates a mapping between frequency resources and the respective first and second antenna panels for PUCCH transmission.

Example A21 may include the one or more NTCRM of example A19-A20, wherein the configuration information indicates PUCCH resources for the PUCCH transmission, wherein the PUCCH resources include a first PUCCH resource and a second resource that are configured with TDM repetition, and wherein the first and second resources are transmitted further using FDM.

Example A22 may include the one or more NTCRM of example A19-A21, wherein the first and second PUCCHs have different formats.

Example A23 may include the one or more NTCRM of any one of examples A19 to A22, wherein the first and second PUCCHs are transmitted to a same transmission-reception point (TRP) or different TRPs.

Example A24 may include the one or more NTCRM of example A21-A23, wherein the first and second PUCCHs are scheduled by a single downlink control information (DCI) or multiple DCIs.

Example B1 may include a method of a gNB, wherein the gNB configures the UE with SRS transmission.

Example B2 may include a method of a UE, wherein the UE can support simultaneous transmission from multiple UE antenna panels.

Example B3 may include the method of example B1 and example B2 or some other example herein, wherein one SRS resource could be configured with multiple spatial relations. If the number of simultaneous active UE antenna panels is N, then one SRS resource could be configured with N spatial relations; one spatial relation corresponds to one UE antenna panel. The SRS resource could be also configured with multiple (e.g., N) close loop power control states, multiple (e.g., N) pathloss reference signals; one close loop power control state/pathloss reference signal corresponds to one UE panel. The number of SRS resource sets of certain time domain behavior for certain SRS usage could be the same as single panel operation (or non-simultaneous transmission from multiple panels). The number of SRS resources within the SRS resource set could be the same as single panel operation (or non-simultaneous transmission from multiple panels).

Example B4 may include the method of example B1 and example B2 or some other example herein, wherein one SRS resource is configured with only one spatial relation/one close loop power control state/one pathloss reference signal. The number of SRS resource sets of certain time domain behavior for certain SRS usage could be the same as single panel operation (or non-simultaneous transmission from multiple panels). The number of SRS resources within one SRS resource set is extended. For example, if the number of SRS resources in one SRS resource set is K for single panel operation, and if the number of simultaneous active UE antenna panels is N, then the number of SRS resources within one SRS resource set could be K*N.

Example B5 may include the method of example B1 and example B2 or some other example herein, wherein one SRS resource is configured with only one spatial relation/one close loop power control state/one pathloss reference signal. The number of SRS resources within one SRS resource set of certain time domain behavior for certain SRS usage could be the same as single panel operation (or non-simultaneous transmission from multiple panels). The number of SRS resource sets is extended. For example, if the number of SRS resource sets is M for single panel operation, and if the number of simultaneous active UE antenna panels is N, then the number of SRS resource sets for multi-panel transmission could be M*N.

Example B6 may include the method of example B1 and example B2 or some other example herein, wherein the UE antenna panel could be identified/associated with SRS spatial relation (or TCI state), or SRS close loop power control state. Or SRS port group could be introduced to identify the UE panels.

Example B7 may include the method of example B1 and example B2 or some other example herein, wherein multiple SRS resource sets with different spatial relations could be transmitted over the same slot. The SRS resources with different spatial relation could be transmitted over the same (or partially overlapped) symbols and/or over the same (or partially overlapped) frequency resources.

Example B8 may include the method of example B1 and example B2 or some other example herein, wherein for single DCI multi-TRP or single TRP operation, the following transmission (over the same carrier or different carrier) is allowed for UE supporting simultaneous transmission from multiple panels:
Overlapped SRS transmission: SRS transmission from one panel, and another SRS transmission from another panel.
Overlapped SRS transmission and PUCCH transmission: SRS transmission from one panel, and PUCCH transmission from another panel.
Overlapped SRS transmission and PUSCH transmission: SRS transmission from one panel, and PUSCH transmission from another panel.
Overlapped SRS transmission and PRACH transmission: SRS transmission from one panel, and PRACH transmission from another panel.

Example B9 may include the method of example B1 and example B2 or some other example herein, wherein for multi-DCI, the following transmission (over the same carrier or different carrier) is allowed for UE supporting simultaneous transmission from multiple panels:
Overlapped SRS transmission: SRS transmission from one panel, and another SRS transmission from another panel. The SRS could be aperiodic/semi-persistent/periodic.

For the transmission over the same panel, the existing collision handling rule could be applied for prioritization among SRS/PUCCH/PUSCH/PRACH.

Example B10 includes a method to be performed by a user equipment (UE) in a wireless network, wherein the method comprises: identifying, by the UE, that the UE is to transmit a first transmission related to a sounding reference signal (SRS) from a first panel of an antenna of the UE; identifying, by the UE, that the UE is to transmit a second transmission from a second panel of the antenna of the UE, wherein the first transmission and the second transmission at least partially overlap in time; identifying, by the UE, one or more SRS resources to be used for the first transmission and the second transmission; and transmitting, by the UE, the first transmission and the second transmission based on the one or more SRS resources.

Example B11 includes the method of example B10, or some other example herein, wherein the first transmission and the second transmission are synchronous.

Example B12 includes the method of example B10, or some other example herein, wherein the first transmission and the second transmission are in a same slot.

Example B13 includes the method of any of examples B10-B12, or some other example herein, wherein the one or more SRS resources include a first spatial relation related to the first transmission and a second spatial relation related to the second transmission.

Example B14 includes the method of any of examples B10-B13, or some other example herein, wherein the one or more SRS resources include a first closed loop power control state related to the first transmission and a second closed loop power control state related to the second transmission.

Example B15 includes the method of any of examples B10-B14, or some other example herein, wherein the one or more SRS resources include a first pathloss reference signal related to the first transmission and a second pathloss reference signal related to the second transmission.

Example B16 includes the method of any of examples B10-B15, or some other example herein, wherein the one or more SRS resources include a first transmission configuration indicator (TCI) related to the first transmission and a second TCI related to the second transmission.

Example B17 includes the method of example B16, or some other example herein, wherein the first or second TCI are indicated by downlink control information (DCI) and/or a medium access control (MAC) control element (MAC-CE).

Example B18 includes the method of any of examples B10-B17, or some other example herein further comprising, by the UE, the SRS resource from a plurality of SRS resource sets, wherein the plurality of SRS resource sets has more SRS resource sets than a number of antenna panels of the antenna of the UE.

Example B19 includes the method of example B18, or some other example herein, wherein the SRS resource set for use by the UE from the plurality of SRS resource sets is indicated by downlink control information (DCI) and/or a medium access control (MAC) control element (MAC-CE).

Example B20 includes the method of any of examples B10-B12, or some other example herein, wherein the SRS resource includes a same spatial relation, closed loop power control state, or pathloss signal related to the first transmission and the second transmission.

Example B21 includes the method of any of examples B10-B20, or some other example herein, wherein the first transmission and the second transmission are related to an SRS port group that identifies panels of the antenna of the UE.

Example B22 includes the method of any of examples B10-B21, or some other example herein, wherein the second transmission is one of an SRS transmission, a physical uplink control channel (PUCCH) transmission, a physical uplink shared channel (PUSCH) transmission, and a physical random access channel (PRACH) transmission.

Example C1 may include a method of a gNB, wherein the gNB configures the UE with PUCCH transmission.

Example C2 may include a method of a UE, wherein the UE supports simultaneous transmission from multiple UE antenna panels.

Example C3 may include the method of example C1 and/or example C2 or some other example herein, wherein PUCCH could be transmitted from multiple panels simultaneously. The PUCCH transmitted from multiple panels could be TDMed, FDMed, or SDMed. The simultaneous PUCCH transmission could be applied to one or several specific PUCCH formats or any PUCCH format.

Example C4 may include the method of example C1 and/or example C2 or some other example herein, wherein one PUCCH resource could be transmitted over same or different frequency resources simultaneously via different UE panels. The mapping between the frequency resource parts and UE panels could be pre-defined.

Example C5 may include the method of example C1 and/or example C2 or some other example herein, wherein different PUCCH resources could be transmitted over the same or different frequency resources simultaneously via different UE panels. One PUCCH resource is configured with TDMed repetition, and another PUCCH resource is also configured with TDMed repetition; then these two PUCCH resources could be further FDMed.

Example C6 may include the method of example C1 and/or example C2 or some other example herein, wherein for single DCI multi-TRP or single TRP operation, the following transmission (over the same carrier or different carrier) is allowed for UE supporting simultaneous transmission from multiple panels:
Overlapped PUCCH transmission: PUCCH transmission from one panel, and another PUCCH transmission from another panel. The PUCCH over multiple panels could be the same or different PUCCH format. The PUCCH over multiple panels could be the same or different PUCCH resource.
Overlapped PUCCH transmission and PUSCH transmission: PUCCH transmission from one panel, and PUSCH transmission from another panel
Overlapped PUCCH transmission and SRS transmission: PUCCH transmission from one panel, and SRS transmission from another panel

Example C7 may include the method of example C1 and/or example C2 or some other example herein, wherein for multi-DCI multi-TRP, the following transmission (over the same carrier or different carrier) is allowed for UE supporting simultaneous transmission from multiple panels:
Overlapped PUCCH transmission: PUCCH transmission from one panel, and another PUCCH transmission from another panel. The PUCCH over multiple panels could be the same or different PUCCH format. The PUCCH over multiple panels could be the same or different PUCCH resource.

Example C8 may include a method of a UE, the method comprising: receiving configuration information for a PUCCH transmission; and transmitting the PUCCH from multiple antenna panels simultaneously.

Example C9 may include the method of example 8 or some other example herein, wherein the PUCCH is transmitted from the multiple antenna panels using time-division multiplexing (TDM), frequency-division multiplexing (FDM), and/or spatial division multiplexing (SDM).

Example C10 may include the method of example C8-C9 or some other example herein, wherein transmitting the PUCCH includes transmitting a PUCCH resource over the same or different frequency resources simultaneously via different antenna panels.

Example C11 may include the method of example C10 or some other example herein, wherein a mapping between the frequency resources and the antenna panels is pre-defined.

Example C12 may include the method of example C8 or some other example herein, wherein transmitting the PUCCH includes transmitting different PUCCH resources over the same or different frequency resources simultaneously via different UE panels.

Example C13 may include the method of example C12 or some other example herein, wherein the PUCCH resources include a first PUCCH resource and a second resource that are configured with TDM repetition, and wherein the first and second resources are transmitted further using FDM.

Example C14 may include the method of example C8-C13 or some other example herein, wherein the PUCCH is configured for single DCI multi-TRP operation or single TRP operation, and wherein the PUCCH is transmitted using one or more of the following modes:
Overlapped PUCCH transmission: PUCCH transmission from one panel, and another PUCCH transmission from another panel. The PUCCH over multiple panels may be the same or different PUCCH format. The PUCCH over multiple panels may be the same or different PUCCH resource.
Overlapped PUCCH transmission and PUSCH transmission: PUCCH transmission from one panel, and PUSCH transmission from another panel
Overlapped PUCCH transmission and SRS transmission: PUCCH transmission from one panel, and SRS transmission from another panel

Example C15 may include the method of example C8-C13 or some other example herein, wherein the PUCCH is configured for multi-DCI multi-TRP operation, and wherein the PUCCH is transmitted using overlapped PUCCH transmission that includes a first PUCCH transmission from a first panel and a second PUCCH transmission from a second panel.

Example C16 may include the method of example C15 or some other example herein, wherein the first and second PUCCH transmissions are the same PUCCH format.

Example C17 may include the method of example C15 or some other example herein, wherein the first and second PUCCH transmissions are different PUCCH formats.

Example C18 may include the method of example C15-C17 or some other example herein, wherein the first and second PUCCH transmissions include the same PUCCH resources.

Example C19 may include the method of example C15-C17 or some other example herein, wherein the first and second PUCCH transmissions include different PUCCH resources.

Example Z01 may include an apparatus comprising means to perform one or more elements of a method described in or related to any of examples A1-A24, B1-B22, C1-C19, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A24, B1-B22, C1-C19, or any other method or process described herein.

Example Z03 may include an apparatus comprising logic, modules, or circuitry to perform one or more elements of a method described in or related to any of examples A1-A24, B1-B22, C1-C19, or any other method or process described herein.

Example Z04 may include a method, technique, or process as described in or related to any of examples A1-A24, B1-B22, C1-C19, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A24, B1-B22, C1-C19, or portions thereof.

Example Z06 may include a signal as described in or related to any of examples A1-A24, B1-B22, C1-C19, or portions or parts thereof.

Example Z07 may include a datagram, packet, frame, segment, protocol data unit (PDU), or message as described in or related to any of examples A1-A24, B1-B22, C1-C19, or portions or parts thereof, or otherwise described in the present disclosure.

Example Z08 may include a signal encoded with data as described in or related to any of examples A1-A24, B1-B22, C1-C19, or portions or parts thereof, or otherwise described in the present disclosure.

Example Z09 may include a signal encoded with a datagram, packet, frame, segment, protocol data unit (PDU), or message as described in or related to any of examples A1-A24, B1-B22, C1-C19, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A24, B1-B22, C1-C19, or portions thereof.

Example Z11 may include a computer program comprising instructions, wherein execution of the program by a processing element is to cause the processing element to carry out the method, techniques, or process as described in or related to any of examples A1-A24, B1-B22, C1-C19, or portions thereof.

Example Z12 may include a signal in a wireless network as shown and described herein. Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

Abbreviations
Unless used differently herein, terms, definitions, and abbreviations
may be consistent with terms, definitions, and abbreviations defined in
3GPP TR 21.905 v16.0.0 (2019 June). For the purposes of the present
document, the following abbreviations may apply to the examples
and embodiments discussed herein.

| | | |
|---|---|---|
| 3GPP Third | AOA Angle of | Shift Keying |
| Generation | Arrival | BRAS Broadband |
| Partnership | AP Application | Remote Access |
| Project | Protocol, Antenna | Server |
| 4G Fourth | Port, Access Point | BSS Business |
| Generation | API Application | Support System |
| 5G Fifth | Programming Interface | BS Base Station |
| Generation | APN Access Point | BSR Buffer Status |
| 5GC 5G Core | Name | Report |
| network | ARP Allocation and | BW Bandwidth |
| AC | Retention Priority | BWP Bandwidth Part |
| Application | ARQ Automatic | C-RNTI Cell |
| Client | Repeat Request | Radio Network |
| ACR Application | AS Access Stratum | Temporary |
| Context Relocation | ASP | Identity |
| ACK | Application Service | CA Carrier |
| Acknowledgement | Provider | Aggregation, |
| | | Certification |
| ACID | ASN.1 Abstract Syntax | Authority |
| Application | Notation One | CAPEX CAPital |
| Client Identification | AUSF Authentication | Expenditure |
| AF Application | Server Function | CBRA Contention |
| Function | AWGN Additive | Based Random |
| AM Acknowledged | White Gaussian | Access |
| Mode | Noise | CC Component |
| AMBRAggregate | BAP Backhaul | Carrier, Country |
| Maximum Bit Rate | Adaptation Protocol | Code, Cryptographic |
| AMF Access and | BCH Broadcast | Checksum |
| Mobility | Channel | CCA Clear Channel |
| Management | BER Bit Error Ratio | Assessment |
| Function | BFD Beam | CCE Control |
| AN Access | Failure Detection | Channel Element |
| Network | BLER Block Error | CCCH Common |
| ANR Automatic | Rate | Control Channel |
| Neighbour Relation | BPSK Binary Phase | CE Coverage |
| Enhancement | Optional | Information |
| CDM Content | CoMP Coordinated | Resource |
| Delivery Network | Multi-Point | Indicator, CSI-RS |
| CDMA Code- | CORESET Control | Resource |
| Division Multiple | Resource Set | Indicator |
| Access | COTS Commercial | C-RNTI Cell |
| CDR Charging Data | Off-The-Shelf | RNTI |
| Request | CP Control Plane, | CS Circuit |
| CDR Charging Data | Cyclic Prefix, | Switched |
| Response | Connection | CSCF call |
| CFRA Contention Free | Point | session control function |
| Random Access | CPD Connection | CSAR Cloud Service |
| CG Cell Group | Point Descriptor | Archive |
| CGF Charging | CPE Customer | CSI Channel-State |
| Gateway Function | Premise | Information |
| CHF Charging | Equipment | CSI-IM CSI |
| Function | CPICHCommon Pilot | Interference |
| CI Cell Identity | Channel | Measurement |
| CID Cell-ID (e.g., | CQI Channel | CSI-RS CSI |
| positioning method) | Quality Indicator | Reference Signal |
| CIM Common | CPU CSI processing | CSI-RSRP CSI |
| Information Model | unit, Central | reference signal |
| CIR Carrier to | Processing Unit | received power |
| Interference Ratio | C/R | CSI-RSRQ CSI |
| CK Cipher Key | Command/Resp | reference signal |
| CM Connection | onse field bit | received quality |
| Management, | CRAN Cloud Radio | CSI-SINR CSI |
| Conditional | Access | signal-to-noise and |
| Mandatory | Network, Cloud | interference |
| CMAS Commercial | RAN | ratio |
| Mobile Alert Service | CRB Common | CSMA Carrier Sense |
| CMD Command | Resource Block | Multiple Access |
| CMS Cloud | CRC Cyclic | CSMA/CA CSMA |
| Management System | Redundancy Check | with collision |
| CO Conditional | CRI Channel-State | avoidance |
| CSS Common | DRB Data Radio | Application Server |
| Search Space, Cell- | Bearer | EASID Edge |
| specific Search | DRS Discovery | Application Server |
| Space | Reference Signal | Identification |
| CTF Charging | DRX Discontinuous | ECS Edge |
| Trigger Function | Reception | Configuration Server |
| CTS Clear-to-Send | DSL Domain | ECSP Edge |
| CW Codeword | Specific Language. | Computing Service |
| CWS Contention | Digital | Provider |
| Window Size | Subscriber Line | EDN Edge |
| D2D Device-to- | DSLAM DSL | Data Network |
| Device | Access Multiplexer | EEC Edge |
| DC Dual | DwPTS | Enabler Client |
| Connectivity, Direct | Downlink Pilot | EECID Edge |
| Current | Time Slot | Enabler Client |
| DCI Downlink | E-LAN Ethernet | Identification |
| Control | Local Area Network | EES Edge |
| Information | E2E End-to-End | Enabler Server |
| DF Deployment | EAS Edge | EESID Edge |
| Flavour | Application Server | Enabler Server |
| DL Downlink | ECCA extended clear | Identification |
| DMTF Distributed | channel | EHE Edge |
| Management Task | assessment, | Hosting Environment |
| Force | extended CCA | EGMF Exposure |
| DPDK Data Plane | ECCE Enhanced | Governance |
| Development Kit | Control Channel | Management |
| DM-RS, DMRS | Element, | Function |
| Demodulation | Enhanced CCE | EGPRS |
| Reference Signal | ED Energy | Enhanced |
| DN Data network | Detection | GPRS |
| DNN Data Network | EDGE Enhanced | EIR Equipment |
| Name | Datarates for GSM | Identity Register |
| DNAI Data Network | Evolution | eLAA enhanced |
| Access Identifier | (GSM Evolution) | Licensed Assisted |
| | EAS Edge | Access, |
| enhanced LAA | eUICC embedded | Information |
| EM Element | UICC, embedded | FCC Federal |
| Manager | Universal | Communications |
| eMBB Enhanced | Integrated Circuit | Commission |
| Mobile | Card | FCCH Frequency |
| Broadband | E-UTRA Evolved | Correction CHannel |
| EMS Element | UTRA | FDD Frequency |
| Management System | E-UTRAN Evolved | Division Duplex |
| eNB evolved NodeB, | UTRAN | FDM Frequency |
| E-UTRAN Node B | EV2X Enhanced V2X | Division |
| EN-DC E- | F1AP F1 Application | Multiplex |
| UTRA-NR Dual | Protocol | FDMA Frequency |
| Connectivity | F1-C F1 Control | Division Multiple |
| EPC Evolved Packet | plane interface | Access |
| Core | F1-U F1 User plane | FE Front End |
| EPDCCH | interface | FEC Forward Error |
| enhanced | FACCH Fast | Correction |
| PDCCH, enhanced | Associated Control | FFS For Further |
| Physical | CHannel | Study |
| Downlink Control | FACCH/F Fast | FFT Fast Fourier |
| Cannel | Associated Control | Transformation |
| EPRE Energy per | Channel/Full | feLAA further |
| resource element | rate | enhanced Licensed |
| EPS Evolved Packet | FACCH/H Fast | Assisted |
| System | Associated Control | Access, further |
| EREG enhanced REG, | Channel/Half | enhanced LAA |
| enhanced resource | rate | FN Frame Number |
| element groups | FACH Forward Access | FPGA Field- |
| ETSI European | Channel | Programmable Gate |
| Telecommunications | FAUSCH Fast | Array |
| Standards | Uplink Signalling | FR Frequency |
| Institute | Channel | Range |
| ETWS Earthquake and | FB Functional | FQDN Fully |
| Tsunami Warning | Block | Qualified Domain |
| System | FBI Feedback | Name |
| G-RNTI GERAN | Radio Service | HPLMN Home |
| Radio Network | GPSI Generic | Public Land Mobile |
| Temporary | Public Subscription | Network |
| Identity | Identifier | HSDPA High |
| GERAN | GSM Global System | Speed Downlink |
| GSM EDGE | for Mobile | Packet Access |
| RAN, GSM EDGE | Communications, | HSN Hopping |
| Radio Access | Groupe Spécial | Sequence Number |
| Network | Mobile | HSPA High Speed |
| GGSN Gateway GPRS | GTP GPRS | Packet Access |
| Support Node | Tunneling Protocol | HSS Home |
| GLONASS | GTP-UGPRS | Subscriber Server |
| GLObal'naya | Tunnelling Protocol | HSUPA High |
| NAvigatsionnaya | for User Plane | Speed Uplink Packet |
| Sputnikovaya | GTS Go To Sleep | Access |
| Sistema (Engl.: | Signal (related | HTTP Hyper Text |
| Global Navigation | to WUS) | Transfer Protocol |
| Satellite | GUMMEI Globally | HTTPS Hyper |
| System) | Unique MME | Text Transfer Protocol |
| gNB Next | Identifier | Secure (https is |
| Generation NodeB | GUTI Globally | http/1.1 over |
| gNB-CU gNB- | Unique Temporary | SSL, i.e. port 443) |
| centralized unit, Next | UE Identity | I-Block |
| Generation | HARQ Hybrid ARQ, | Information |
| NodeB | Hybrid | Block |
| centralized unit | Automatic | ICCID Integrated |
| gNB-DU gNB- | Repeat Request | Circuit Card |
| distributed unit, Next | HANDO Handover | Identification |
| Generation | HFN HyperFrame | IAB Integrated |
| NodeB | Number | Access and |
| distributed unit | HHO Hard Handover | Backhaul |
| GNSS Global | HLR Home Location | ICIC Inter-Cell |
| Navigation Satellite | Register | Interference |
| System | HN Home Network | Coordination |
| GPRS General Packet | HO Handover | ID Identity, |
| identifier | IMGI International | Identity Module |
| IDFT Inverse Discrete | mobile group identity | ISO International |
| Fourier | IMPI IP Multimedia | Organisation for |
| Transform | Private Identity | Standardisation |
| IE Information | IMPU IP Multimedia | ISP Internet Service |
| element | PUblic identity | Provider |
| IBE In-Band | IMS IP Multimedia | IWF Interworking- |
| Emission | Subsystem | Function |
| IEEE Institute of | IMSI International | I-WLAN |
| Electrical and | Mobile | Interworking |
| Electronics | Subscriber | WLAN |
| Engineers | Identity | Constraint |
| IEI Information | IoT Internet of | length of the |
| Element | Things | convolutional |
| Identifier | IP Internet | code, USIM |
| IEIDL Information | Protocol | Individual key |
| Element | Ipsec IP Security, | kB Kilobyte (1000 |
| Identifier Data | Internet Protocol | bytes) |
| Length | Security | kbps kilo-bits per |
| IETF Internet | IP-CAN IP- | second |
| Engineering Task | Connectivity Access | Kc Ciphering key |
| Force | Network | Ki Individual |
| IF Infrastructure | IP-M IP Multicast | subscriber |
| IIOT Industrial | IPV4 Internet | authentication |
| Internet of Things | Protocol Version 4 | key |
| IM Interference | IPv6 Internet | KPI Key |
| Measurement, | Protocol Version 6 | Performance Indicator |
| Intermodulation, | IR Infrared | KQI Key Quality |
| IP Multimedia | IS In Sync | Indicator |
| IMC IMS | IRP Integration | KSI Key Set |
| Credentials | Reference Point | Identifier |
| IMEI International | ISDN Integrated | ksps kilo-symbols |
| Mobile | Services Digital | per second |
| Equipment | Network | KVM Kernel Virtual |
| Identity | ISIM IM Services | Machine |
| L1 Layer 1 | Positioning Protocol | and Orchestration |
| (physical layer) | LSB Least | MBMS |
| L1-RSRP Layer 1 | Significant Bit | Multimedia |
| reference signal | LTE Long Term | Broadcast and |
| received power | Evolution | Multicast |
| L2 Layer 2 (data | LWA LTE-WLAN | Service |
| link layer) | aggregation | MBSFN |
| L3 Layer 3 | LWIP LTE/WLAN | Multimedia |
| (network layer) | Radio Level | Broadcast |
| LAA Licensed | Integration with | multicast |
| Assisted Access | IPsec Tunnel | service Single |
| LAN Local Area | LTE Long Term | Frequency |
| Network | Evolution | Network |
| LADN Local | M2M Machine-to- | MCC Mobile Country |
| Area Data Network | Machine | Code |
| LBT Listen Before | MAC Medium Access | MCG Master Cell |
| Talk | Control | Group |
| LCM LifeCycle | (protocol | MCOTMaximum |
| Management | layering context) | Channel |
| LCR Low Chip Rate | MAC Message | Occupancy |
| LCS Location | authentication code | Time |
| Services | (security/encryption | MCS Modulation and |
| LCID Logical | context) | coding scheme |
| Channel ID | MAC-A MAC | MDAF Management |
| LI Layer Indicator | used for | Data Analytics |
| LLC Logical Link | authentication | Function |
| Control, Low Layer | and key | MDAS Management |
| Compatibility | agreement | Data Analytics |
| LMF Location | (TSG T WG3 context) | Service |
| Management Function | MAC-IMAC used for | MDT Minimization of |
| LOS Line of | data integrity of | Drive Tests |
| Sight | signalling messages | ME Mobile |
| LPLMN Local | (TSG T WG3 context) | Equipment |
| PLMN | MANO | MeNB master eNB |
| LPP LTE | Management | MER Message Error |
| Ratio | MPRACH MTC | Machine-Type |
| MGL Measurement | Physical Random | Communications |
| Gap Length | Access | |
| MGRP Measurement | CHannel | MU-MIMO Multi |
| Gap Repetition | MPUSCH MTC | User MIMO |
| Period | Physical Uplink Shared | MWUS MTC |
| MIB Master | Channel | wake-up signal, MTC |
| Information Block, | MPLS MultiProtocol | WUS |
| Management | Label Switching | NACK Negative |
| Information Base | MS Mobile Station | Acknowledgement |
| MIMO Multiple Input | MSB Most | NAI Network |
| Multiple Output | Significant Bit | Access Identifier |
| MLC Mobile | MSC Mobile | NAS Non-Access |
| Location Centre | Switching Centre | Stratum, Non- Access |
| MM Mobility | MSI Minimum | Stratum layer |
| Management | System | NCT Network |
| MME Mobility | Information, | Connectivity |
| Management Entity | MCH Scheduling | Topology |
| MN Master Node | Information | NC-JT Non- |
| MNO Mobile | MSID Mobile Station | Coherent Joint |
| Network Operator | Identifier | Transmission |
| MO Measurement | MSIN Mobile Station | NEC Network |
| Object, Mobile | Identification | Capability |
| Originated | Number | Exposure |
| MPBCH MTC | MSISDN Mobile | NE-DC NR-E- |
| Physical Broadcast | Subscriber ISDN | UTRA Dual |
| CHannel | Number | Connectivity |
| MPDCCH MTC | MT Mobile | NEF Network |
| Physical Downlink | Terminated, Mobile | Exposure Function |
| Control | Termination | NF Network |
| CHannel | MTC Machine-Type | Function |
| MPDSCH MTC | Communications | NFP Network |
| Physical Downlink | | Forwarding Path |
| Shared | mMTCmassive MTC, | NFPD Network |
| CHannel | massive | Forwarding Path |
| Descriptor | Shared CHannel | S-NNSAI Single |
| NFV Network | NPRACH | NSSAI |
| Functions | Narrowband | NSSF Network Slice |
| Virtualization | Physical Random | Selection Function |
| NFVI NFV | Access CHannel | NW Network |
| Infrastructure | NPUSCH | NWUSNarrowband |
| NFVO NFV | Narrowband | wake-up signal, |
| Orchestrator | Physical Uplink | Narrowband WUS |
| NG Next | Shared CHannel | NZP Non-Zero |
| Generation, Next Gen | NPSS Narrowband | Power |
| NGEN-DC NG- | Primary | O&M Operation and |
| RAN E-UTRA-NR | Synchronization | Maintenance |
| Dual Connectivity | Signal | ODU2 Optical channel |
| NM Network | NSSS Narrowband | Data Unit-type 2 |
| Manager | Secondary | OFDM Orthogonal |
| NMS Network | Synchronization | Frequency Division |
| Management System | Signal | Multiplexing |
| N-PoP Network Point | NR New Radio, | OFDMA |
| of Presence | Neighbour Relation | Orthogonal |
| NMIB, N-MIB | NRF NF Repository | Frequency Division |
| Narrowband MIB | Function | Multiple Access |
| NPBCH | NRS Narrowband | OOB Out-of-band |
| Narrowband | Reference Signal | OOS Out of |
| Physical | NS Network | Sync |
| Broadcast | Service | OPEX OPerating |
| CHannel | NSA Non-Standalone | EXpense |
| NPDCCH | operation mode | OSI Other System |
| Narrowband | NSD Network | Information |
| Physical | Service Descriptor | OSS Operations |
| Downlink | NSR Network | Support System |
| Control CHannel | Service Record | OTA over-the-air |
| NPDSCH | NSSAINetwork Slice | PAPR Peak-to- |
| Narrowband | Selection | Average Power |
| Physical | Assistance | Ratio |
| Downlink | Information | PAR Peak to |
| Average Ratio | Network, Public | PP, PTP Point-to- |
| PBCH Physical | Data Network | Point |
| Broadcast Channel | PDSCH Physical | PPP Point-to-Point |
| PC Power Control, | Downlink Shared | Protocol |
| Personal | Channel | PRACH Physical |
| Computer | PDU Protocol Data | RACH |
| PCC Primary | Unit | PRB Physical |
| Component Carrier, | PEI Permanent | resource block |
| Primary CC | Equipment | PRG Physical |
| P-CSCF Proxy | Identifiers | resource block |
| CSCF | PFD Packet Flow | group |
| PCell Primary Cell | Description | ProSe Proximity |
| PCI Physical Cell | P-GW PDN Gateway | Services, |
| ID, Physical Cell | PHICH Physical | Proximity- |
| Identity | hybrid-ARQ indicator | Based Service |
| PCEF Policy and | channel | PRS Positioning |
| Charging | PHY Physical layer | Reference Signal |
| Enforcement | PLMN Public Land | PRR Packet |
| Function | Mobile Network | Reception Radio |
| PCF Policy Control | PIN Personal | PS Packet Services |
| Function | Identification Number | PSBCH Physical |
| PCRF Policy Control | PM Performance | Sidelink Broadcast |
| and Charging Rules | Measurement | Channel |
| Function | PMI Precoding | PSDCH Physical |
| PDCP Packet Data | Matrix Indicator | Sidelink Downlink |
| Convergence | PNF Physical | Channel |
| Protocol, Packet | Network Function | PSCCH Physical |
| Data Convergence | PNFD Physical | Sidelink Control |
| Protocol layer | Network Function | Channel |
| PDCCH Physical | Descriptor | PSSCH Physical |
| Downlink Control | PNFR Physical | Sidelink Shared |
| Channel | Network Function | Channel |
| PDCP Packet Data | Record | PSCell Primary SCell |
| Convergence Protocol | POC PTT over | PSS Primary |
| PDN Packet Data | Cellular | Synchronization |
| Signal | Channel | RLC UM RLC |
| PSTN Public Switched | RADIUS Remote | Unacknowledged |
| Telephone Network | Authentication Dial | Mode |
| PT-RS Phase-tracking | In User Service | RLF Radio Link |
| reference signal | RAN Radio Access | Failure |
| PTT Push-to-Talk | Network | RLM Radio Link |
| PUCCH Physical | RAND RANDom | Monitoring |
| Uplink Control | number (used for | RLM-RS |
| Channel | authentication) | Reference |
| PUSCH Physical | RAR Random Access | Signal for RLM |
| Uplink Shared | Response | RM Registration |
| Channel | RAT Radio Access | Management |
| QAM Quadrature | Technology | RMC Reference |
| Amplitude | RAU Routing Area | Measurement Channel |
| Modulation | Update | RMSI Remaining |
| QCI QoS class of | RB Resource block, | MSI, Remaining |
| identifier | Radio Bearer | Minimum |
| QCL Quasi co- | RBG Resource block | System |
| location | group | Information |
| QFI QoS Flow ID, | REG Resource | RN Relay Node |
| QoS Flow | Element Group | RNC Radio Network |
| Identifier | Rel Release | Controller |
| QoS Quality of | REQ REQuest | RNL Radio Network |
| Service | RF Radio | Layer |
| QPSK Quadrature | Frequency | RNTI Radio Network |
| (Quaternary) Phase | RI Rank Indicator | Temporary |
| Shift Keying | RIV Resource | Identifier |
| QZSS Quasi-Zenith | indicator value | ROHC RObust Header |
| Satellite System | RL Radio Link | Compression |
| RA-RNTI Random | RLC Radio Link | RRC Radio Resource |
| Access RNTI | Control, Radio | Control, Radio |
| RAB Radio Access | Link Control | Resource Control |
| Bearer, Random | layer | layer |
| Access Burst | RLC AM RLC | RRM Radio Resource |
| RACH Random Access | Acknowledged Mode | 105 Management |
| RS | Reference | Identity |
| Signal | S-TMSI SAE | Protocol |
| RSRP Reference | Temporary Mobile | SDAP Service Data |
| Signal Received | Station | Adaptation |
| Power | Identifier | Protocol, |
| RSRQ Reference | SA Standalone | Service Data |
| Signal Received | operation mode | Adaptation |
| Quality | SAE System | Protocol layer |
| RSSI Received Signal | Architecture | SDL Supplementary |
| Strength | Evolution | Downlink |
| Indicator | SAP Service Access | SDNF Structured Data |
| RSU Road Side Unit | Point | Storage Network |
| RSTD Reference | SAPD Service Access | Function |
| Signal Time | Point Descriptor | SDP Session |
| difference | SAPI Service Access | Description Protocol |
| RTP Real Time | Point Identifier | SDSF Structured Data |
| Protocol | SCC Secondary | Storage Function |
| RTS Ready-To-Send | Component Carrier, | SDT Small Data |
| RTT Round Trip | Secondary CC | Transmission |
| Time | SCell Secondary Cell | SDU Service Data |
| Rx Reception, | SCEF Service | Unit |
| Receiving, Receiver | Capability Exposure | SEAF Security |
| S1AP S1 Application | Function | Anchor Function |
| Protocol | SC-FDMA Single | SeNB secondary eNB |
| S1-MME S1 for | Carrier Frequency | SEPP Security Edge |
| the control plane | Division | Protection Proxy |
| S1-U S1 for the user | Multiple Access | SFI Slot format |
| plane | SCG Secondary Cell | indication |
| S-CSCF serving | Group | SFTD Space- |
| CSCF | SCM Security | Frequency Time |
| S-GW Serving | Context | Diversity, SFN |
| Gateway | Management | and frame timing |
| S-RNTI SRNC | SCS Subcarrier | difference |
| Radio Network | Spacing | SFN System Frame |
| Temporary | SCTP Stream Control | Number |
| SgNB Secondary gNB | Network | Signal Received |
| SGSN Serving GPRS | SpCell Special Cell | Power |
| Support Node | SP-CSI-RNTISemi- | SS-RSRQ |
| S-GW Serving | Persistent CSI RNTI | Synchronization |
| Gateway | SPS Semi-Persistent | Signal based |
| SI System | Scheduling | Reference |
| Information | SQN Sequence | Signal Received |
| SI-RNTI System | number | Quality |
| Information RNTI | SR Scheduling | SS-SINR |
| SIB System | Request | Synchronization |
| Information Block | SRB Signalling | Signal based Signal |
| SIM Subscriber | Radio Bearer | to Noise and |
| Identity Module | SRS Sounding | Interference Ratio |
| SIP Session | Reference Signal | SSS Secondary |
| Initiated Protocol | SS Synchronization | Synchronization |
| SiP System in | Signal | Signal |
| Package | SSB Synchronization | SSSG Search Space |
| SL Sidelink | Signal Block | Set Group |
| SLA Service Level | SSID Service Set | SSSIF Search Space |
| Agreement | Identifier | Set Indicator |
| SM Session | SS/PBCH Block | SST Slice/Service |
| Management | SSBRI SS/PBCH | Types |
| SMF Session | Block Resource | SU-MIMO Single |
| Management Function | Indicator, | User MIMO |
| SMS Short Message | Synchronization | SUL Supplementary |
| Service | Signal Block | Uplink |
| SMSF SMS Function | Resource | TA Timing |
| SMTC SSB-based | Indicator | Advance, Tracking |
| Measurement Timing | SSC Session and | Area |
| Configuration | Service | TAC Tracking Area |
| SN Secondary | Continuity | Code |
| Node, Sequence | SS-RSRP | TAG Timing |
| Number | Synchronization | Advance Group |
| SoC System on Chip | Signal based | TAI |
| SON Self-Organizing | Reference | Tracking Area |
| Identity | Indicator | Function |
| TAU Tracking Area | TR Technical | UICC Universal |
| Update | Report | Integrated Circuit |
| TB Transport Block | TRP, TRxP | Card |
| TBS Transport Block | Transmission | UL Uplink |
| Size | Reception Point | UM |
| TBD To Be Defined | TRS Tracking | Unacknowledged |
| TCI Transmission | Reference Signal | Mode |
| Configuration | TRx Transceiver | UML Unified |
| Indicator | TS Technical | Modelling Language |
| TCP Transmission | Specifications, | UMTS Universal |
| Communication | Technical | Mobile |
| Protocol | Standard | Telecommunications |
| TDD Time Division | TTI Transmission | System |
| Duplex | Time Interval | UP User Plane |
| TDM Time Division | Tx Transmission, | UPF User Plane |
| Multiplexing | Transmitting, | Function |
| TDMA Time Division | Transmitter | URI Uniform |
| Multiple Access | U-RNTI UTRAN | Resource Identifier |
| TE Terminal | Radio Network | URL Uniform |
| Equipment | Temporary | Resource Locator |
| TEID Tunnel End | Identity | URLLC Ultra- |
| Point Identifier | UART Universal | Reliable and Low |
| TFT Traffic Flow | Asynchronous | Latency |
| Template | Receiver and | USB Universal Serial |
| TMSI Temporary | Transmitter | Bus |
| Mobile | UCI Uplink Control | USIM Universal |
| Subscriber | Information | Subscriber Identity |
| Identity | UE User Equipment | Module |
| TNL Transport | UDM Unified Data | USS UE-specific |
| Network Layer | Management | search space |
| TPC Transmit Power | UDP User Datagram | UTRA UMTS |
| Control | Protocol | Terrestrial Radio |
| TPMI Transmitted | UDSF Unstructured | Access |
| Precoding Matrix | Data Storage Network | UTRAN |
| Universal | Network | |
| Terrestrial Radio | VPN Virtual Private | |
| Access | Network | |
| Network | VRB Virtual | |
| UwPTS Uplink | Resource Block | |
| Pilot Time Slot | WiMAX | |
| V2I Vehicle-to- | Worldwide | |
| Infrastruction | Interoperability | |
| V2P Vehicle-to- | for Microwave | |
| Pedestrian | Access | |
| V2V Vehicle-to- | WLANWireless Local | |
| Vehicle | Area Network | |
| V2X Vehicle-to- | WMAN Wireless | |
| everything | Metropolitan Area | |
| VIM Virtualized | Network | |
| Infrastructure Manager | WPANWireless | |
| VL Virtual Link, | Personal Area Network | |
| VLAN Virtual LAN, | X2-C X2-Control | |
| Virtual Local Area | plane | |
| Network | X2-U X2-User plane | |
| VM Virtual | XML extensible | |
| Machine | Markup | |
| VNF Virtualized | Language | |
| Network Function | XRES Expected user | |
| VNFFG VNF | RESponse | |
| Forwarding Graph | XOR exclusive OR | |
| VNFFGD VNF | ZC Zadoff-Chu | |
| Forwarding Graph | ZP Zero Power | |
| Descriptor | | |
| VNFM VNF Manager | | |
| VoIP Voice-over-IP, | | |
| Voice-over- Internet | | |
| Protocol | | |
| VPLMN | | |
| Visited | | |
| Public Land Mobile | | |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-24. (canceled)

25. One or more non-transitory computer-readable media (NTCRM) having instructions, stored thereon, that when executed by one or more processors of a user equipment (UE) configure the UE to:
receive sounding reference signal (SRS) configuration information for a first SRS transmission on a first antenna panel of the UE and a second SRS transmission on a second antenna panel of the UE, wherein the first and second SRS transmissions at least partially overlap in time; and
transmit the first and second SRS transmissions based on the SRS configuration information.

26. The one or more NTCRM of claim 25, wherein the first SRS transmission and the second SRS transmission are synchronous; or

27. The one or more NTCRM of claim 25, wherein the first SRS transmission and the second SRS transmission are in a same slot.

28. The one or more NTCRM of claim 25, wherein the SRS configuration information includes a first spatial relation for the first SRS transmission and a second spatial relation for the second SRS transmission.

29. The one or more NTCRM of claim 25, wherein the SRS configuration information includes a first closed loop power control state for the first SRS transmission and a second closed loop power control state for the second SRS transmission.

30. The one or more NTCRM of claim 25, wherein the SRS configuration information indicates a first pathloss reference signal related to the first SRS transmission and a second pathloss reference signal related to the second SRS transmission.

31. The one or more NTCRM of claim 25, wherein the SRS configuration information includes a first transmission configuration indicator (TCI) related to the first transmission and a second TCI related to the second transmission.

32. The one or more NTCRM of claim 25, wherein the SRS configuration information indicates a plurality of SRS resource sets, and wherein the instructions, when executed, are further to configure the UE to receive a downlink control information (DCI) or a medium access control (MAC) control element (MAC-CE) to indicate one or more of the SRS resource sets to use.

33. The one or more NTCRM of claim 32, wherein the first and second SRS transmissions are transmitted based on a same spatial relation, closed loop power control state, or pathloss reference signal.

34. One or more non-transitory computer-readable media having instructions, stored thereon, that when executed by one or more processors of a next generation Node B (gNB) configure the gNB to:
encode, for transmission to a user equipment (UE), sounding reference signal (SRS) configuration information for a first SRS transmission on a first antenna panel of the UE and a second SRS transmission on a second antenna panel of the UE, wherein the first and second SRS transmissions at least partially overlap in time; and
receive at least one of the first or second SRS transmissions based on the SRS configuration information.

35. The one or more NTCRM of claim 34, wherein the first SRS transmission and the second SRS transmission are synchronous.

36. The one or more NTCRM of claim 34, wherein the first SRS transmission and the second SRS transmission are in a same slot.

37. The one or more NTCRM of claim 34, wherein the SRS configuration information includes:
a first spatial relation for the first SRS transmission and a second spatial relation for the second SRS transmission;
a first closed loop power control state for the first SRS transmission and a second closed loop power control state for the second SRS transmission.
a first pathloss reference signal related to the first SRS transmission and a second pathloss reference signal related to the second SRS transmission; or
a first transmission configuration indicator (TCI) related to the first transmission and a second TCI related to the second transmission.

38. The one or more NTCRM of claim 34, wherein the SRS configuration information indicates a plurality of SRS resource sets, and wherein the instructions, when executed, are further to configure the gNB to transmit a downlink control information (DCI) or a medium access control (MAC) control element (MAC-CE) to the UE to indicate one or more of the SRS resource sets to use.

39. The one or more NTCRM of claim 38, wherein the SRS configuration information is to configure the UE to transmit the first and second SRS transmissions based on a same spatial relation, closed loop power control state, or pathloss reference signal.

40. One or more non-transitory computer-readable media (NTCRM) having instructions, stored thereon, that when executed by one or more processors of a user equipment (UE) configure the UE to:
receive configuration information for physical uplink control channel (PUCCH) transmission using multiple antenna panels;
transmit a first PUCCH on a first antenna panel based on the configuration information; and
transmit a second PUCCH on a second antenna panel based on the configuration information, wherein the second PUCCH is at least partially overlapped in time with the first PUCCH, and wherein the first and second PUCCHs are transmitted using time-division multiplexing (TDM), frequency-division multiplexing (FDM), and/or spatial division multiplexing (SDM).

41. The one or more NTCRM of claim 40, wherein the configuration information indicates a mapping between frequency resources and the respective first and second antenna panels for PUCCH transmission.

42. The one or more NTCRM of claim 40, wherein the configuration information indicates PUCCH resources for the PUCCH transmission, wherein the PUCCH resources include a first PUCCH resource and a second resource that are configured with TDM repetition, and wherein the first and second resources are transmitted further using FDM.

43. The one or more NTCRM of claim 40, wherein the first and second PUCCHs have different formats.

44. The one or more NTCRM of claim 40, wherein the first and second PUCCHs are transmitted to a same transmission-reception point (TRP) or different TRPs; and
wherein the first and second PUCCHs are scheduled by a single downlink control information (DCI) or multiple DCIs.
